(19) United States
(12) Patent Application Publication
(10) Pub. No.: US 2010/0071309 A1
(43) Pub. Date: Mar. 25, 2010

(54) SOIL STABILIZATION SYSTEM, STABILIZED SOIL COMPRISING SAME, AND A METHOD OF STABILIZING SOIL

(76) Inventors: Charles D. Brangan, Anchorage, AK (US); John K. Newman, Vicksburg, MS (US); Robert Vitale, Canton, OH (US)

Correspondence Address: Albuquerque Engineer District;ATTN: CESPA-OC, 4101 Jefferson Pl. NE, Albuquerque, NM, 87109-3434, US

(21) Appl. No.: 12/432,842

(22) Filed: Apr. 30, 2009

Related U.S. Application Data
(60) Provisional application No. 61/126,129, filed on May 1, 2008.

(51) Int. Cl. E02D 27/00; C09K 17/18; C09K 17/20; E02D 3/00

(52) U.S. Cl. 52/741.15; 523/132; 405/302.4

(57) ABSTRACT

A soil stabilization system, method of stabilizing soil, and a stabilized soil having improved engineering characteristics such as increased bearing ratio and improved triaxial compression characteristics. Select embodiments comprise one or more lipophilic fluid mixtures, fibers which may be synthetic, natural or both, the lipophilic fluid and fibers mixed into soil of a pre-specified moisture content in pre-specified dry soil weight ratios. The system is optimized by adjusting the moisture content of the soil to a pre-specified figure prior to treatment, by compacting the treated soil to a pre-specified standard and finally by aging the resultant compacted treated soil for a pre-specified period to optimize engineering characteristics thereof. Select embodiments are suitable for use at temperatures approaching −60° F.

### RELATED APPLICATIONS

Under 35 U.S.C. §119(e)(1), this application claims the benefit of prior co-pending U.S. Provisional Patent Application Ser. No. 61/126,129, A SOIL STABILIZATION SYSTEM, STABILIZED SOIL COMPRISING SAME, AND A METHOD OF STABILIZING SOIL, by Newman et al., filed May 1, 2008, and incorporated herein by reference.

### STATEMENT OF GOVERNMENT INTEREST

Under paragraph 1(a) of Executive Order 10096, the conditions under which this invention was made entitle the Government of the United States, as represented by the Secretary of the Army, to an undivided interest therein on any patent granted thereon by the United States. This and related patents are available for licensing to qualified licensees. Please contact Phillip Stewart at 601 634-4113.

### BACKGROUND

The most commonly used materials for stabilizing soils or marginal aggregates are asphalt, portland cement, lime, and fly ash. These stabilizing agents are known as “traditional stabilizers”, and the literature is full of examples and well-documented case studies about their use. However, as technology and understanding of soil stabilization mechanisms improved, additional methods and products termed “non-traditional stabilizers” have been developed. Electrolytes, enzymes, mineral pitches, clay fillers and acrylic polymers are examples.

### BRIEF DESCRIPTION OF DRAWINGS

FIG. 1 depicts overlapping particle distribution curves from sieve analysis tests for a silty sand soil used in tests of select embodiments of the present invention.

FIG. 2 plots Dry Density versus Moisture Content, showing an OMC of about 11% for a silty sand soil used in tests of select embodiments of the present invention, yielding an optimum peak density soil to be stabilized using select embodiments of the present invention.

FIG. 3 plots California Bearing Ratio (CBR) versus Depth of Penetration for the silty sand soil used in tests of select embodiments of the present invention and demonstrates that soil at the optimum moisture content displays the highest bearing capacity at each 0.100 inch of penetration relative to soils with other moisture contents.

FIG. 4 presents CBR values versus four values of fiber content for the silty sand soil for five discrete depths of penetration showing that optimum CBR is near 0.5 wt % dry soil of added fiber.

FIG. 5 plots Percent Synthetic Fluid versus Dry Density used in testing select embodiments of the present invention versus dry density for the silty sand soil overlain with the percent moisture versus dry density curve of FIG. 2.

FIG. 6 plots CBR values versus Depth of Penetration for samples of the silty sand soil used in testing select embodiments of the present invention mixed with synthetic fluid and water mixtures in three separate ratios.

FIG. 7 plots CBR values versus Depth of Penetration for samples of the silty sand soil used in testing select embodiments of the present invention mixed with fiber at 0.5 wt % dry soil, water and synthetic fluid; the fluid mixtures in three separate ratios of water and synthetic fluid.

FIG. 8 plots CBR values versus Depth of Penetration for samples of the silty sand soil used in testing select embodiments of the present invention at five separate percent weight ratios of water only to dry soil.

FIG. 9 plots CBR values versus five values of fiber content for the silty sand soil for five discrete depths of penetration showing that optimum CBR is near 0.625 wt % dry soil of added fiber at the deeper penetrations but near 0.5 wt % dry soil at the shallower penetrations.

FIG. 10 plots CBR values versus Depth of Penetration for samples of the silty sand soil used in testing select embodiments of the present invention mixed with fiber at various wt % dry soil, water at 11 wt % dry soil again showing that optimum CBR is near 0.625 wt % dry soil of added fiber at the deeper penetrations but near 0.5 wt % dry soil at the shallower penetrations.

FIG. 11 plots CBR values versus Depth of Penetration for samples of the silty sand soil used in testing select embodiments of the present invention mixed with synthetic fluid at various wt % dry soil, water at 6 wt % dry soil and no fibers showing that optimum CBR is 6 to 7 wt % dry soil of synthetic fluid.

FIG. 12 plots CBR values versus Depth of Penetration for samples of the silty sand soil used in testing select embodiments of the present invention mixed with fiber at 0.5 wt % dry soil, water at 6 wt % dry soil and synthetic fluid at varying wt % dry soil, showing that CBR values increase with depth of penetration and are nearly equal for each different wt % dry soil of synthetic fluid.

FIG. 13 plots the deviatoric stress-axial versus strain response from a Unconsolidated-Undrained (UU) Triaxial test for four separate samples at a water content of 11 wt % of dry soil with no synthetic fluid or fiber added and four compression, σ₃, values.

FIG. 14 plots the Mohr failure envelope for the four σ₃ values of FIG. 13 at a φ of 41.8° and c=2.9 psi.

FIG. 15 plots the deviatoric stress-axial versus strain response from a UU Triaxial test for three separate samples at a water content of 11 wt % of dry soil with fibers added at 0.5 wt % dry soil and no synthetic fluid added and σ₃ values of 2.5 psi, 5.0 psi and 10.0 psi, respectively, showing stress still climbing at a strain over 14% for all values of σ₃, the stress leveling at over about 150 psi for σ₃ of 10.0 psi.

FIG. 16 plots the Mohr failure envelope for the three σ₃ values of FIG. 15 at a φ of 43.7° and c=23.5 psi.

FIG. 17 plots the deviatoric stress-axial versus strain response from a UU Triaxial test for three separate samples at a water content of 6 wt % of dry soil with fibers added at 0.5 wt % dry soil, synthetic fluid added at 5 wt % dry soil and three separate values of σ₃.

FIG. 18 plots the Mohr failure envelope for the three σ₃ values of FIG. 17 at a φ of 53.6° and c=11.2 psi.

FIG. 19 plots the deviatoric stress-axial versus strain response from a UU Triaxial test for three separate samples at a water content of 6 wt % of dry soil with fibers added at 0.5 wt % dry soil, synthetic fluid added at 3 wt % dry soil and three separate σ₃ values.

FIG. 20 plots the Mohr failure envelope for the three σ₃ values of FIG. 19 at a φ of 48.5° and c=13.9 psi.

FIG. 21 plots the deviatoric stress-axial versus strain response from a UU Triaxial test for three separate samples at a water content of 6 wt % of dry soil with fibers added at 0.5 wt % dry soil, synthetic fluid added at 7 wt % dry soil and three separate σ₃ values.

FIG. 22 plots the Mohr failure envelope for the three σ₃ values of FIG. 21 at a φ of 55.6° and c=4.9 psi.

FIG. 23 plots CBR values versus Depth of Penetration for samples of the silty sand soil used in testing select embodiments of the present invention mixed with and without fiber at 0.5 wt % dry soil, water at 11 wt % dry soil and no synthetic fluid.

FIG. 24 plots CBR values versus Depth of Penetration for samples of the silty sand soil used in testing select embodiments of the present invention mixed with and without synthetic fluid at 3.0 wt % dry soil, water at 6 wt % dry soil and no fibers.

FIG. 25 plots CBR values versus Depth of Penetration for two samples of the silty sand soil used in testing select embodiments of the present invention, one sample mixed with and without synthetic fluid at 5.0 wt % dry soil, water at 6 wt % dry soil and no fibers and a second sample with water at 11.0 wt % dry soil and no synthetic fluid or fibers.

FIG. 26 plots CBR values versus Depth of Penetration for samples of the silty sand soil used in testing select embodiments of the present invention, one sample mixed with and without synthetic fluid at 7.0 wt % dry soil, water at 6 wt % dry soil and no fibers and a second sample with water at 13.0 wt % dry soil and no synthetic fluid or fibers.

FIG. 27 plots CBR values versus Depth of Penetration for samples of the silty sand soil used in testing select embodiments of the present invention, one sample mixed with and two without synthetic fluid; a first sample with synthetic fluid at 5.0 wt % dry soil, water at 6 wt % dry soil and fibers at 0.5 wt % dry soil; a second sample with water at 11.0 wt % dry soil and no synthetic fluid or fibers; and a third sample without synthetic fluid, water at 11.0 wt % dry soil and fibers at 0.5 wt % dry soil.

FIG. 28 plots CBR values versus Depth of Penetration for samples of the silty sand soil used in testing select embodiments of the present invention, using the samples of FIG. 27 but aging them for 10 days.

FIG. 29A plots CBR values versus Depth of Penetration for samples of the silty sand soil used in testing select embodiments of the present invention compacted at a non-standard value (NS) and the Modified Proctor (MDP) standard with water only at 11.0 wt % dry soil.

FIG. 29B plots CBR values versus Depth of Penetration for samples of the silty sand soil used in testing select embodiments of the present invention compacted at a non-standard value (NS) and the Modified Proctor (MDP) standard with water at 11.0 wt % dry soil and added fibers at 0.5 wt % dry soil.

FIG. 29C plots CBR values versus Depth of Penetration for samples of the silty sand soil used in testing select embodiments of the present invention compacted at a non-standard value (NS) and the Modified Proctor (MDP) standard with no fibers, water at 6.0 wt % dry soil and synthetic fluid at 5.0 wt % dry soil for a total moisture content of 11.0 wt % dry soil.

FIG. 30A plots the deviatoric stress-axial versus strain response from a UU Triaxial test for five separate samples at a confining pressure of 2.5 psi.

FIG. 30B plots the deviatoric stress-axial versus strain response from a UU Triaxial test for the five separate samples of FIG. 30A at a confining pressure of 5.0 psi.

FIG. 30C plots the deviatoric stress-axial versus strain response from a UU Triaxial test for the five separate samples of FIG. 30A at a confining pressure of 10.0 psi.

FIG. 31 includes photos of two soil columns stressed equally showing the different failure mechanisms of one treated with a select embodiment of the present invention and the other untreated.

### DETAILED DESCRIPTION

Select embodiments of the present invention provide a soil stabilization system comprised of a fluid mixture comprising one or more lipophilic fluids mixed with fibers, either synthetic, natural, or both. Further, in select embodiments of the present invention a method of applying select embodiments of the present invention to soil having an optimized moisture content (OMC) is provided. Select embodiments of the present invention also comprise stabilized soil established using select embodiments of the present invention.

By mixing lipophilic fluid and fibers, including synthetic or natural fibers, either alone or in combination with natural and synthetic fibers, into soil, the soil exhibited unexpectedly improved engineering properties. These improvements were to characteristics including California Bearing Ratio (CBR), friction angle, cohesion, and the like. These improved engineering characteristics are superior to those obtained by using either the mixture containing the lipophilic fluid alone or the fibers alone. Finally, an unexpected synergy occurs when mixing lipophilic fluid and fibers into soil having an optimum moisture content (OMC) in a certain weight ratio (based on dry soil weight percent).

In select embodiments of the present invention, a soil stabilization system comprises: a first fluid mixture comprising one or more lipophilic fluids and fibers, such that the first fluid mixture and fibers are mixed into soil to create a second approximately homogeneous mixture of the soil, fibers and first fluid mixture and such that the second mixture is compacted to a pre-specified standard and aged for a pre-specified time, resulting in a soil with improved stability.

In select embodiments of the present invention, the lipophilic fluid comprises a highly branched isoalkane having 10 to about 25 carbon atoms and the first fluid mixture further comprises biodiesel fuel. In select embodiments of the present invention, the isoalkane remains liquid to at least about −60° F.

In select embodiments of the present invention, the first fluid mixture further comprises at least one petroleum-based fluid.

In select embodiments of the present invention the fibers comprise synthetic fibers. In select embodiments of the present invention, the fibers may be comprised of: nylon, polyvinyl alcohol, polyethylene, polypropylene, natural rubber, synthetic rubber, styrene butadiene, isoprene, cellulose and combinations thereof. In select embodiments of the present invention, the fibers comprise monofilament fibers. In select embodiments of the present invention, the fibers comprise fibrillated fibers. In select embodiments of the present invention, the fibers have a length of about 6.25 mm (about 0.25 inches) to about 100 mm (about 4 inches).

In select embodiments of the present invention, a stabilized soil comprises: a soil having a pre-specified moisture content; a first fluid mixture comprising one or more lipophilic fluids; and fibers; such that the first fluid mixture and the fibers are mixed in the soil to create an approximately homogeneous second mixture of the soil, the fibers and the first fluid mixture, and such that the homogeneous second mixture is compacted to a pre-specified standard and aged for a pre-specified time to yield the stabilized soil.

In select embodiments of the present invention, the lipophilic fluid comprises a highly branched isoalkane having about 10 to about 25 carbon atoms and the first fluid mixture further comprises biodiesel fuel. In select embodiments of the present invention, the isoalkane used for the stabilized soil remains liquid down to at least about −60° F.

In select embodiments of the present invention, the stabilized fibers used in the stabilized soil may be comprised of: nylon, polyvinyl alcohol, polyethylene, polypropylene, natural rubber, synthetic rubber, styrene butadiene, isoprene, cellulose and combinations thereof. In select embodiments of the present invention, the stabilized soil is provided at a moisture of a pre-specified weight percent of dry soil, such that providing soil at an optimized moisture content (OMC) as a pre-specified weight percent of dry soil facilitates compaction and attaining pre-specified engineering properties of the stabilized soil.

In select embodiments of the present invention, the stabilized soil is comprised of the first fluid mixture at about 5 wt % dry soil, moisture at about 6 wt % dry soil and the fibers at about 0.5 wt % dry soil.

In select embodiments of the present invention, a method of stabilizing soil comprises: providing soil at a pre-specified moisture content; providing a first fluid mixture comprising at least one lipophilic fluid; providing fibers; and mixing into the soil to be stabilized the first fluid mixture and the fibers to achieve an approximately homogeneous second mixture of the soil to be stabilized, the first fluid mixture and the fibers; compacting the second homogeneous mixture to a pre-specified standard; and aging the compacted second homogeneous mixture for a pre-specified period, such that the method yields stabilized soil having improved engineering properties.

In select embodiments of the present invention, the method provides the lipophilic fluid as a highly branched isoalkane having 10 to about 25 carbon atoms and the first fluid mixture further comprises biodiesel fuel. In select embodiments of the present invention, the method provides a isoalkane that remains liquid down to about −60° F.

In select embodiments of the present invention, the method provides fibers that may be comprised of: nylon, polyvinyl alcohol, polyethylene, polypropylene, natural rubber, synthetic rubber, styrene butadiene, isoprene, cellulose and combinations thereof.

In select embodiments of the present invention, the method further provides for adjusting the moisture content of the soil to be stabilized to a pre-specified percent dry weight of soil.

In select embodiments of the present invention, the pre-specified standard used in the method is the Modified Proctor compaction method.

In select embodiments of the present invention, the method employs a pre-specified period for curing of about ten days.

In select embodiments of the present invention, the method provides the lipophilic fluid in a range of about 1 to about 10 wt % dry soil and the fibers in a range of about 0.1 to 2 wt % dry soil to a soil with a moisture content in a range of about 2 to about 10 wt % dry soil.

In select embodiments of the present invention, structure built on a foundation is provided, the foundation at least comprising: a soil to be stabilized having a pre-specified moisture content; a first fluid mixture comprising at least one lipophilic fluid; and fibers, such that the first fluid mixture and the fibers are mixed in the soil to be stabilized to create an approximately homogeneous second mixture of the soil to be stabilized, the fibers and the first fluid mixture, and such that the homogeneous second mixture is compacted to a pre-specified standard and aged for a pre-specified time to yield a stabilized soil for the foundation.

In select embodiments of the present invention, a method for constructing a foundation for structure at least comprises: testing soil to be used for the foundation to determine at least moisture content thereof; adjusting the soil to at least a pre-specified moisture content as necessary; providing a first fluid mixture comprising at least one lipophilic fluid; providing fibers; and mixing into the soil of an adjusted pre-specified moisture content the first fluid mixture and the fibers to achieve an approximately homogeneous second mixture of the soil adjusted to a pre-specified moisture content, the first fluid mixture and the fibers; compacting the second homogeneous mixture to a pre-specified standard; and aging the compacted second homogeneous mixture for a pre-specified period, such that the method yields stabilized soil for the foundation.

In select embodiments of the present invention, the lipophilic fluid is a highly branched isoalkane having from about 10 to about 25 carbon atoms and biodiesel. In select embodiments of the present invention the biodiesel may be replaced with a petroleum-based fluid. In select embodiments of the present invention the biodiesel may be augmented with a petroleum-based fluid.

In select embodiments of the present invention, one or more lipophilic fluids and fibers are mixed into soil, preferably OMC soil, in a ratio of about 1 to about 10 wt % lipophilic fluid, and about 0.1 to about 2 wt % of fibers, either synthetic or natural fibers, or a pre-specified combination of synthetic and natural fibers, based on dry soil weight. In select embodiments of the present invention, mixing this approximate ratio of components into soil, preferably OMC soil, provides unexpectedly improved engineering properties.

In select embodiments of the present invention, water is added to soil to be stabilized such that the soil comprises from about 3 to about 20 wt % water based on dry soil weight. This addition creates an OMC soil for optimum density during compaction. In a most preferred embodiment, about 5 wt % of a lipophilic fluid and about 0.5 wt % fibers are added to soil to be stabilized, along with sufficient water such that the soil has a moisture content of about 6 wt %, all based on dry soil weight. For select embodiments of the present invention, the amount of water to be added to the soil is dependent upon the type of soil being stabilized, and the existing moisture content therein.

Preferably, in select embodiments of the present invention the lipophilic fluid is a composition that maintains liquidity above about −60° F., enabling use in arctic or subarctic areas. In select embodiments of the present invention, a lipophilic fluid is a severely hydro-treated paraffinic fluid, such as EARTH ARMOUR-ARCTIC® that maintains a low viscosity at very low temperatures, easing mixture throughout hard, frozen soils. However, if select embodiments of the present invention are to be used in warmer climates a fluid having a higher freezing point and higher viscosity may be used.

In select embodiments of the present invention, fibers may comprise nylon, polyvinyl alcohol, polyethylene, polypropylene, natural and synthetic rubbers (styrene butadiene and isoprene), cellulose and combinations of the above, and the like. In select embodiments of the present invention the fibers may comprise monofilament, fibrillated fibers, and the like having a length of from about 6.5 to about 100 mm (about 0.25 to about 4 inches). In select embodiments, preferably the fibers are fibrillated polypropylene fibers having a length of about 50 to about 75 mm (about 2 to about 3 inches), such as GEOFIBERS®. In select embodiments of the present invention, preferably the fibers are cellulose fibers that may be derived from natural sources, such as plants and trees. Note that use of cellulose fibers may be preferred in environmentally sensitive locations, e.g., where biodegradability is a goal.

In select embodiments of the present invention, a method of stabilizing soil comprises mixing a soil stabilization system into soil. In select embodiments of the present invention, a method of stabilizing soil comprises mixing into soil about 1 to about 10 wt % of one or more lipophilic fluids, and from about 0.1 to about 2 wt % of a polymeric fiber, a natural fiber, or both, all based on dry soil weight. In select embodiments of the present invention, water is added to the soil in an amount sufficient to provide a soil moisture content of about 3 to about 20 wt %, based on dry soil weight. In select embodiments of the present invention, the fibers and fluid are mixed sufficiently throughout the soil to facilitate a pre-specified compaction of the treated soil.

In select embodiments of the present invention, after select embodiments of the present invention are mixed into soil, a compacting step compresses (compacts) the soil to obtain a pre-specified density of the soil to meet a user's needs under field conditions. The pre-specified density of the soil depends on the type of soil being stabilized. For example, compacted sand may have a higher maximum density than compacted clay. In select embodiments of the present invention, to ensure compaction provides a pre-specified density, water is added to the soil to create an OMC soil, facilitating attainment of optimum density during the compaction step.

### Test Results

Soil improvement was evaluated in terms of CBR and triaxial compressive strength, in accordance with ASTM or AASHTO testing protocols. Soil index properties were evaluated for: specific gravity in accordance with ASTM D854-06; soil gradation in accordance with ASTM C136-06; optimum moisture content and maximum dry density in accordance with ASTM D1557-02) and liquid limit, plastic limit, and plasticity index on the soil fines in accordance with ASTM D43 18-00.

CBR tests were performed in accordance with ASTM D1883-05, and compaction in accordance with ASTM D1557-02. Additional CBR tests were conducted with non-standard compaction to observe compaction-dependent changes. Unconsolidated-Undrained (UU) Triaxial Compression tests were performed in accordance with AASHTO T296-05. Tests were conducted on: native soil samples; samples of soils reinforced with geofibers only; samples of soils stabilized with a synthetic fluid only; samples of soils stabilized with a combination of geofibers and synthetic fluid; and the above four sets of samples with non-standard compaction.

Laboratory test data were reviewed to compare CBR values obtained from native soil samples with improved soil samples and to evaluate the stress-strain response and the compressive strength from UU Triaxial testing.

The components used for testing were silty sand from Bethel, Ak. (USCS class: SM); FiberSoils GEOFIBERS® 3627BT and Earth Armour Limited's Earth Armour—Arctic, a severely hydro-treated paraffinic synthetic fluid.

A selected test mixture contained a fiber content of 0.625% of a sample dry soil unit weight and a water content of 11% of the sample dry soil unit weight (11.0 wt % dry soil). Soil for the samples was supplied in three separate containers. Soil from each container was transferred to pans and placed in an oven at 105° C. to dry to constant mass. Next, the soil from each pan was mixed with the others to make a single, comparable lot from which to take samples. This lot was then split and stored in three sealed containers. Sieve analysis was performed on samples taken from two of the three containers. Test results served as a quality control check to verify consistency between storage containers filled after mixing and again splitting the oven-dried soil.

The specific gravity of the Bethel silty sand was found according to ASTM D864-06. The specific gravity test was performed by placing 50 g of soil in the pycnometer with distilled water. Entrapped air was removed from the soil-water mix by applying vacuum. Next, measurements were performed to determine the unknowns for the following equation:

GTₓ=Wₒ[Wₒ+Wₐ−W_{b}] Eqn. (1)

where:
Wₒ=weight of sample of oven-dried soil, g
Wₐ=weight of pycnometer filled with water at temperature Tₓ, g
W_{b}=weight of pycnometer filled with water and soil at temperature Tₓ, g
Tₓ=Temperature of the contents of the pycnometer when W_{b} was determined, ° C.

The specific gravity of the Bethel silty sand sample was found to be 2.59 at a temperature of 20° C.

Sieve analysis testing was performed in accordance with ASTM C 136-06 using U.S. Standard eight-inch diameter sieves. The sieve stack contained the following sizes, stacked in order of decreasing opening size: #4, #16, #30, #50, #100, #140, #200, and a pan. Weights were obtained using a Mettler PC1616 digital scale, balanced and verified with calibration weights to read within 0.1 gram. Each test sample was split and measured to approximately, but no less than, one kilogram.

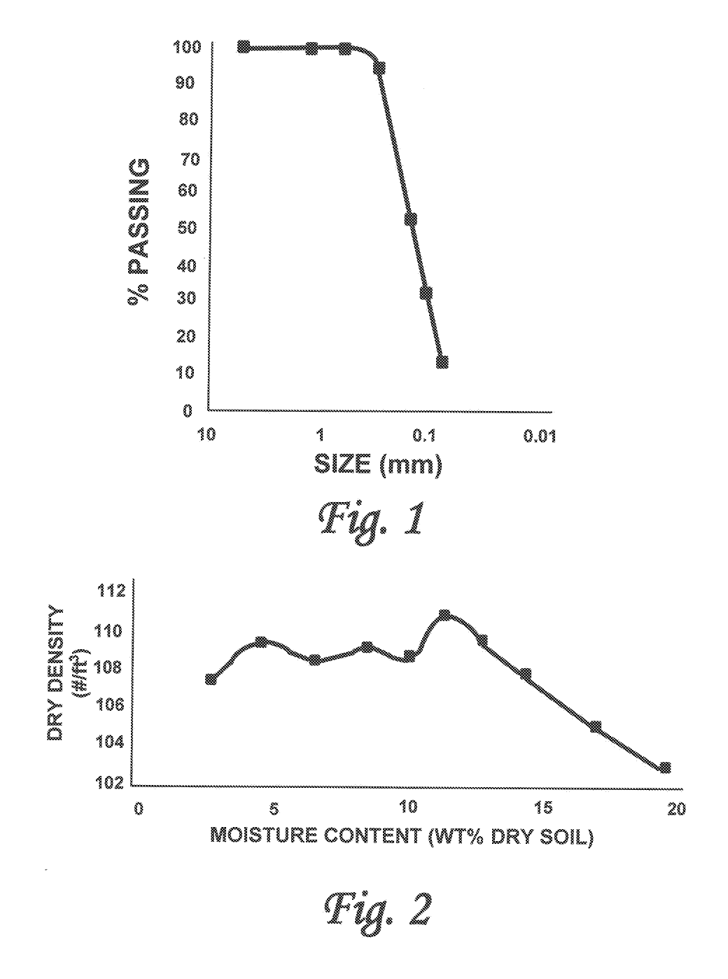

The sieve stack and soil samples were placed in a Tyler Ro-Tap 8″ RX-29 (Model B) shaker, and then shaken for fifteen minutes. After shaking, the contents on each sieve were weighed in cumulative fashion and the percent passing each sieve was calculated. Refer to FIG. 1, showing the overlapping particle distribution curves from the sieve analysis tests. The two samples gave nearly identical curves, indicating that the sample lot was consistent in gradation between storage containers. Consistency of the third container was assumed to be similar to that of the first two.

The optimum moisture content and dry density of the Bethel silty sand were found in accordance with ASTM D1557-02. A Mettler PC1616 digital scale and a Sartorius 60,000 g digital scale were used to weigh samples. Approximately 2 kg dry soil samples were weighed out. Water was provided within 0.1 g of the target moisture content for each test. Target moisture contents of up to 20% of the dry soil weight were tested in 2% increments. The soil and water test samples were hand-mixed and stored in sealed containers for a minimum of one hour before compaction. Compaction was performed by a SoilTest Mechanical Soil Compactor (model CN-4235) in four-inch diameter molds conforming to the requirements of ASTM D1557-02. Each test was performed in five lifts and twenty-five blows per lift using a round foot on a mechanical rammer. After compaction, the test samples were dried, either in whole or in part, to determine the resulting moisture content. Data points separated by greater than 2% moisture content near the apparent optimum moisture point were supplemented by additional tests. Moisture contents were estimated to split the difference.

Refer to FIG. 2 showing an OMC of about 11%, corresponding to a dry density of 110.8 lb/ft³. To find the liquid and plastic limits of the Bethel silty sand, researchers followed procedures outlined in ASTM D43 18-84. The sand was found to be non-plastic and the number of blows required to close the groove was always less than 25. Thus, the liquid limit could not be determined.

CBR testing was conducted in accordance with ASTM D1883-05. Compaction was performed in accordance with ASTM D1557-02, in molds meeting the requirements of ASTM D1883-05, including spacer. For the non-standard compaction, the test was performed in accordance with ASTM D698-00a, except that a drop height of eighteen inches was used instead of twelve inches. The six-inch molds conformed to the requirements of ASTM D698-00a. Compaction was performed by a SoilTest Mechanical Soil Compactor (model CN-4235). A sectional foot was used on the mechanical rammer for all CBR samples. The CBR test apparatus was a SoilTest G-900 VersaLoader, having a maximum capacity of 10,000 pounds. Prior to testing, the proof-ring load was correlated with a recently calibrated 22,000 lb load cell and digital readout. Testing was conducted at a speed of approximately 0.050 in/min. Test readings were taken, as a minimum, at the following displacements: 0.025 in., 0.050 in., 0.075 in., 0.100 in., 0.125 in., 0.150 in., 0.175 in., 0.200 in., 0.300 in., 0.400 in., and 0.500 in. For some tests, readings were taken at each 0.025 inch displacement through the entire test range of zero to 0.5 inches. The soil samples were not soaked, and a surcharge of 10 lbs was used. A nomenclature was adopted for identifying samples: “SFC/MC/F”, where SFC was the synthetic fluid content as a percentage of dry soil weight (wt % dry soil), MC was the moisture content as wt % dry soil, and F was the geofiber content as wt % dry soil. For example, a sample identified as “3/6/0.5” had an estimated synthetic fluid content of 3 wt % dry soil, an estimated water content of 6 wt % dry soil, and an estimated fiber content of 0.5 wt % dry soil. Similarly, samples identified as “0/11/0” had a water content target of 11.0 wt % dry soil and no synthetic fluid or fiber. The actual amount of moisture content in the sample was measured and recorded after oven drying.

Test samples with liquid contents of synthetic fluid and water mixtures were reported as estimated quantities of each of these components. Similarly, the dry density is an estimate for these samples. Samples that contained water as the only liquid were oven-dried at 105° C. to determine moisture content. The calculated dry density was reported. Oven-drying was not an adequate procedure for samples with liquid contents of synthetic fluid and water mixtures. No readily available means of identifying the ratio of loss of water to loss of synthetic fluid during oven-drying was found, and thus estimates were used instead of quantifiable amounts. The following assumptions were made regarding synthetic fluid and water mixtures: total liquid loss is negligible and synthetic fluid and water are evenly distributed within the sample.

CBR tests were conducted on mixtures of soil and water: at OMC of a target value of 11.0 wt % dry soil, i.e., “0/11/0”; at OMC plus 2%, a target value of 13 wt % dry soil, i.e., “0/13/0”; and at OMC minus 2%, a target value of 9.0 wt % dry soil, i.e., “0/9/0”. Dry soil samples of 4.5 kg were combined with water measured to within 0.1 g of the target. The soil and water samples were hand-mixed and stored in sealed containers for at least one hour before testing. Care was taken to ensure minimal moisture loss during testing. Samples were mixed, compacted, tested for bearing capacity, and then removed from the test mold, loosened by hand, and re-mixed with remaining material. Each CBR test consisted of a series of three compactions and bearing tests on the same soil mixture. CBR values are the average of these three tests. The entire mold of the third test of the series was oven-dried to determine moisture content. The exception to this procedure was the test sample with a moisture target of 13.0 wt % dry soil. This test was conducted on three separate samples due to water loss of up to 0.5 wt % dry soil that bled out during compaction and bearing testing. Moisture contents in the other series of compaction and bearing tests showed minimal loss, e.g., less than 0.2% of the target.

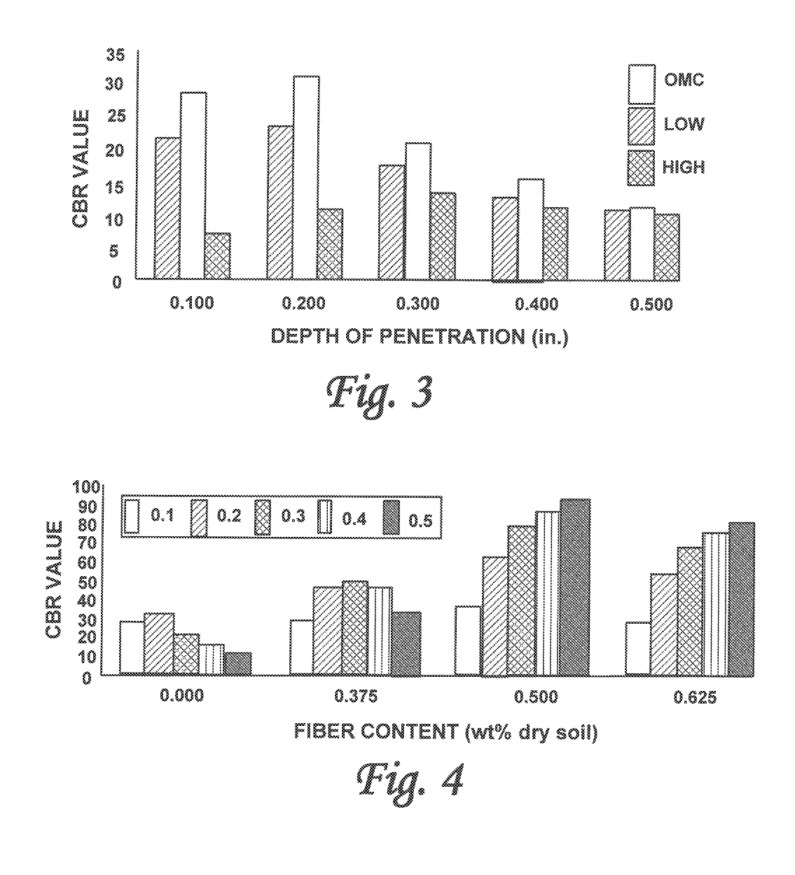

Refer to FIG. 3 presenting test results for native soil samples. Results show that soil at the optimum moisture content displays the highest bearing capacity at each 0.100 inch of penetration, relative to soils with other moisture contents, i.e., either higher or lower. The CBR value at OMC was found to be 31.5 at 0.200 inch of penetration.

Following OMC tests on native soil samples with varying moisture contents, tests were conducted to determine optimum fiber content (OFC). Initially, a process similar to the optimum moisture content standard, ASTM D1557-02, was used: moisture content was held constant at the OMC and varying amounts of geofibers of 2.75 in. nominal length were added to samples. Tests in standard four-inch molds produced a percent fiber versus dry density curve that gave inconclusive results. That is, dry density values did not change more than 1 lb/ft³ between 0.3% and 1.0% and sharply declined as fiber content increased greater than 1.0% of dry soil weight. Thus, four-inch molds do not appear to have sufficient space for the fibers to adequately disperse to their full length in the compacted soil. In their product literature, FiberSoils suggests that “dosage rates are typically determined to be 0.1 to 0.3 percent of the soil's dry unit weight”, although they do not state to which soil types this recommendation applies. Field application of select embodiments of the present invention was noted as “polypropylene soil fibers at 0.15 pounds per square foot—blended uniformly to 6 inch depth and compacted.” The Cape Simpson, Alaska material (USCS class: SP) used in the field application had a dry density of 108.98 lb/ft³ using ASTM D698 for compaction. The amount of geofibers used at Cape Simpson was calculated to be approximately 0.45 wt % dry soil.

CBR tests were conducted on mixtures of soil, water, and geofiber at the OMC, i.e., a target value of 11.0 wt % dry soil. Investigation of optimum fiber content started at 0.5 wt % dry soil, and was varied by 0.125% above and below, labeled as tests “0/11/0.375”, “0/11/0.5”, and “0/11/0.625”. As with the tests on native soil samples, each sample was weighed out at 4.5 Kg and moisture content was established to within 0.1 g of target. The soil was hand-mixed and stored in sealed containers at least one hour before mixing with the fibers. Fiber content was established to within 0.1 g of target. Fibers were mixed into the soil by adding alternating layers of soil and fiber to a stainless-steel mixing bowl. The bowl contents were then mixed by hand, using a manipulation technique that simulated “roto-tilling” action, until the fibers were evenly distributed. Samples were mixed, compacted, tested for bearing capacity, and then removed from the test mold, loosened by hand, and re-mixed with remaining material. Each CBR test consisted of a series of three compactions and bearing tests on the same soil mixture. CBR values reported are the average of these three tests. Care was taken to ensure minimal moisture loss during testing. A portion of the third test of the series was oven-dried to determine moisture content. The remainder was compacted and set aside to age in ambient room conditions for one week prior to performing a bearing test on this aged sample.

Refer to FIG. 4, presenting CBR values at various geofiber contents, ranging from 0 to 0.625% for five discrete depths of penetration from 0.1 to 0.5 in. in 0.1 in. increments. From this data, bearing capacity is near 0.5 wt % dry soil. By adding 0.5% fiber at OMC, the CBR value at 0.200 inch penetration increases from 31.5 (FIG. 3) to 63.8 (FIG. 4), a 102.5% improvement in CBR value.

In other practical applications such as may be used in oil field services, synthetic fluid is typically used at one quarter of the amount of water added (1:4). For example, 2.0 wt % dry soil of synthetic fluid to 8 wt % dry soil of water. The soil optimum synthetic fluid content (OSFC) and estimated dry density were investigated in a procedure similar to that used to find the OMC, in accordance with ASTM D1557-02. Compaction was performed by a SoilTest Mechanical Soil Compactor (model CN-4235). Weights were obtained with a Mettler PC1616 digital scale and a Sartorius 60,000 g digital scale. Compaction in standard four-inch molds for all samples was performed in five lifts and twenty-five blows per lift using a round foot on the hammer. Dry soil samples were weighed out at approximately 2 kg and synthetic fluid was added in small incremental percentages of dry soil weight. The samples were hand-mixed and stored in sealed containers for a minimum of 30 minutes before compaction. After compaction, an estimated dry density was calculated based on two assumptions: that none of the synthetic fluid was lost during compaction and that the synthetic fluid was evenly dispersed in the soil. While mixing the synthetic (containing at least one lipophilic fluid) fluid mixture with the dry soil, the fluid mixture tended to form clumps in the soil, not readily dispersing as water does, especially when mixing small amounts. Substantial effort was made to ensure even dispersal of fluid, e.g., clumps were broken up by hand and mixing continued until the soil mixture appeared homogeneous.

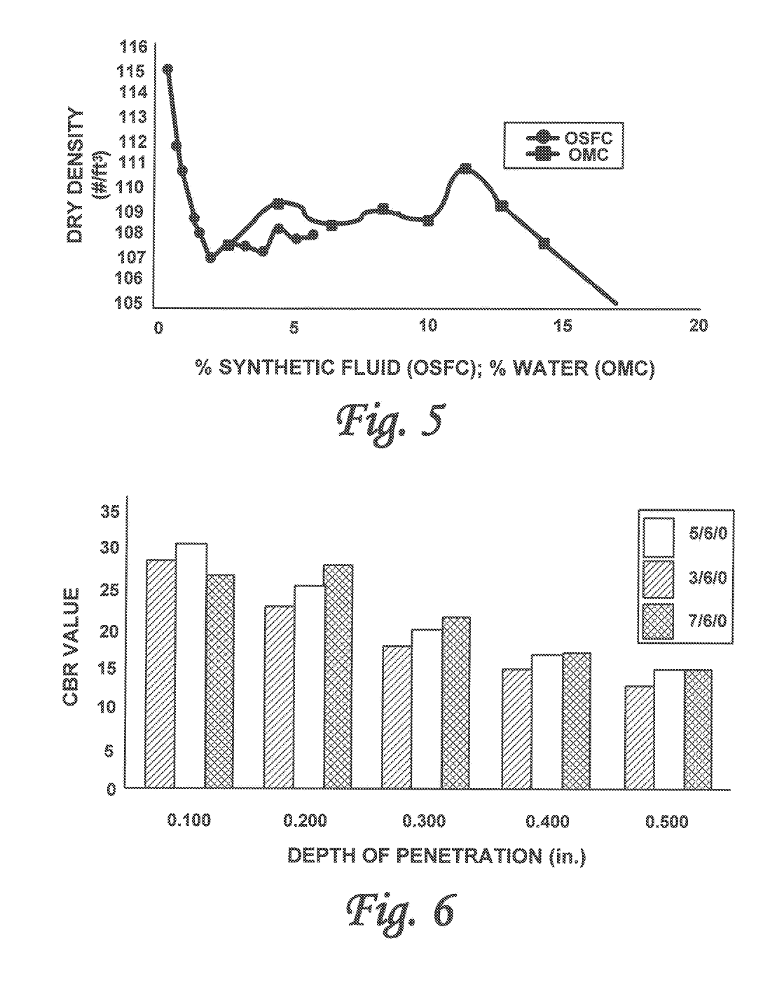

Refer to FIG. 5, a curve of percent synthetic fluid versus dry density plotted and overlain with the percent moisture versus dry density curve. Results for finding the OSFC using the method described above were inconclusive. The two curves appear similar to each other, and further investigation using dry soil and synthetic fluid without any water content was abandoned in favor of a different technique. A quick, but significant, test was performed to explore the effect of using a mixture of synthetic fluid and water, but substantially altering the ratio of synthetic fluid-to-water while keeping the total liquid content the same. The total liquid content was held at the OMC point (11.0 wt % dry soil) and two mixes were chosen: 3/8/0 and 7/4/0. Despite the difference in ratio of synthetic fluid-to-water, the estimated dry densities of the two compaction tests resulted in a difference of less than 0.1 lb/ft³.

Applying a rule-of-thumb that the in-situ moisture content is between 60 and 70% of optimum, further tests were conducted holding the moisture constant at 6.0 wt % dry soil and varying the synthetic fluid content above and below the total liquid content of 11.0 wt % fry soil. Three mixtures were selected for testing: 3/6/0, 5/6/0, and 7/6/0. Mixture 5/6/0 was chosen to match the total liquid content of 11.0 wt % dry soil. The other two mixtures represent varying the fluid content by 2.0 wt % dry soil on either side of the 11.0 wt % dry soil total liquid content.

Dry soil samples were weighed out to 4.5 kg, and water was provided to within 0.1 g of target. The samples were hand-mixed and stored in sealed containers for at least one hour before mixing with the synthetic fluid. The synthetic fluid was provided to within 0.1 g of target. The samples were hand-mixed and stored in sealed containers for at least 30 minutes before testing. Care was taken to ensure minimal moisture loss during mixing and testing. Samples were mixed, compacted, tested for bearing capacity, and then removed from the test mold, loosened by hand, and re-mixed with remaining material. Each CBR test consisted of a series of three compactions and bearing tests on the same soil mixture. CBR values reported are the average of these three tests. After compaction, estimated dry densities were calculated.

Refer to FIG. 6 showing CBR values for samples of Bethel silty sand mixed with Earth Armour—Arctic® synthetic fluid and water mixtures in three separate ratios.

To observe the effects of combining synthetic fluid with geofibers on the bearing capacity of Bethel silty sand, the following samples were prepared for CBR testing: 3/6/0.5, 5/6/0.5, and 7/6/0.5. As by the nomenclature, the moisture content (6.0 wt % dry soil) and “optimum” fiber content (0.5 wt % dry soil) were held constant and the amount of synthetic fluid was varied on either side of the optimum liquid content of 11.0 wt % dry soil (±2.0 wt % dry soil). Dry soil samples were weighed out to 4.5 kg, and water was provided to within 0.1 g of target. The samples were hand-mixed and stored in sealed containers for at least one hour before mixing with the synthetic fluid. The synthetic fluid was provided to within 0.1 g of target. The samples were hand-mixed and stored in sealed containers for at least 30 minutes before testing. Care was taken to ensure minimal moisture loss during mixing and testing. Fibers were mixed into the soil by adding alternating layers of soil and fiber to a stainless-steel mixing bowl. The bowl contents were then mixed by hand using a manipulation technique that simulated “roto-tilling” action until the fibers were evenly distributed. Samples were mixed, compacted, tested for bearing capacity, and then removed from the test mold, loosened by hand, and re-mixed with remaining material. Each test consisted of a series of three compactions and bearing tests on the same soil mixture. Reported CBR values are the average of these three tests. After the third bearing test was performed, the remaining material was compacted and set aside to age in ambient room conditions for one week prior to performing a bearing test on these aged samples. After compaction, an estimated dry density was calculated.

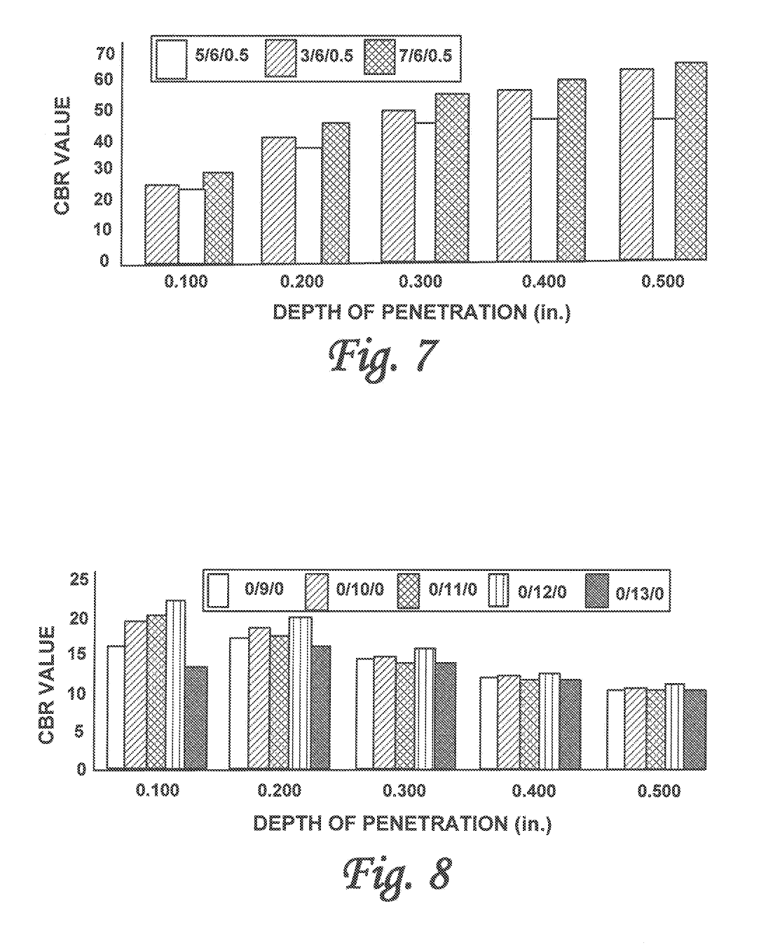

Refer to FIG. 7, showing test results from samples containing a constant fiber addition and varying synthetic fluid and water mixtures. CBR values from the sample with five percent synthetic fluid and six percent water “plateau” whereas CBR values for the other mixtures continue to increase. Note that the ordinate of FIG. 7 (fiber added) uses CBR values twice that of FIG. 6 (no fiber added).

Refer to FIG. 8 plotting CBR values versus Depth of Penetration for samples of the silty sand soil used in testing select embodiments of the present invention at five separate percent weight ratios of water only to dry soil. Note that the CBR values are much lower than that shown for FIG. 7 and indicate insignificant differences from 9.0 wt % dry soil to 13 wt % dry soil moisture content of the soil to be stabilized with 11 wt % dry soil being the median value.

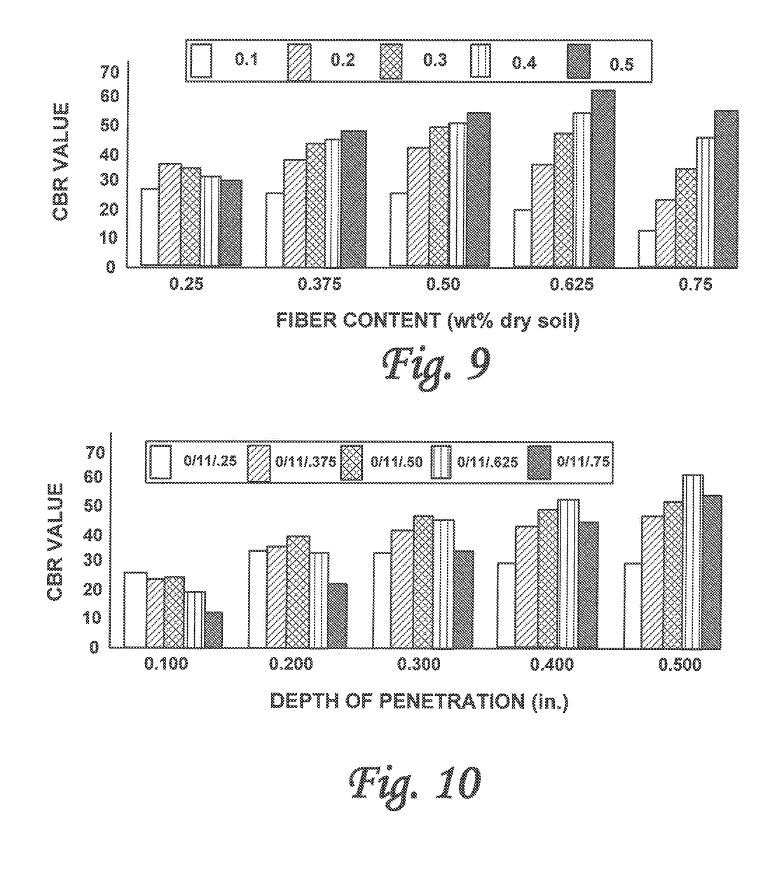

Refer to FIG. 9 plotting CBR values versus five values of fiber content for the silty sand soil for five discrete depths of penetration showing that optimum CBR is near 0.625 wt % dry soil of added fiber at the deeper penetrations but near 0.5 wt % dry soil at the shallower penetrations.

Refer to FIG. 10 plotting CBR values versus Depth of Penetration for samples of the silty sand soil used in testing select embodiments of the present invention mixed with fiber at various wt % dry soil, water at 11 wt % dry soil and no synthetic fluid. Again, this shows that optimum CBR is near 0.625 wt % dry soil of added fiber at the deeper penetrations but near 0.5 wt % dry soil at the shallower penetrations.

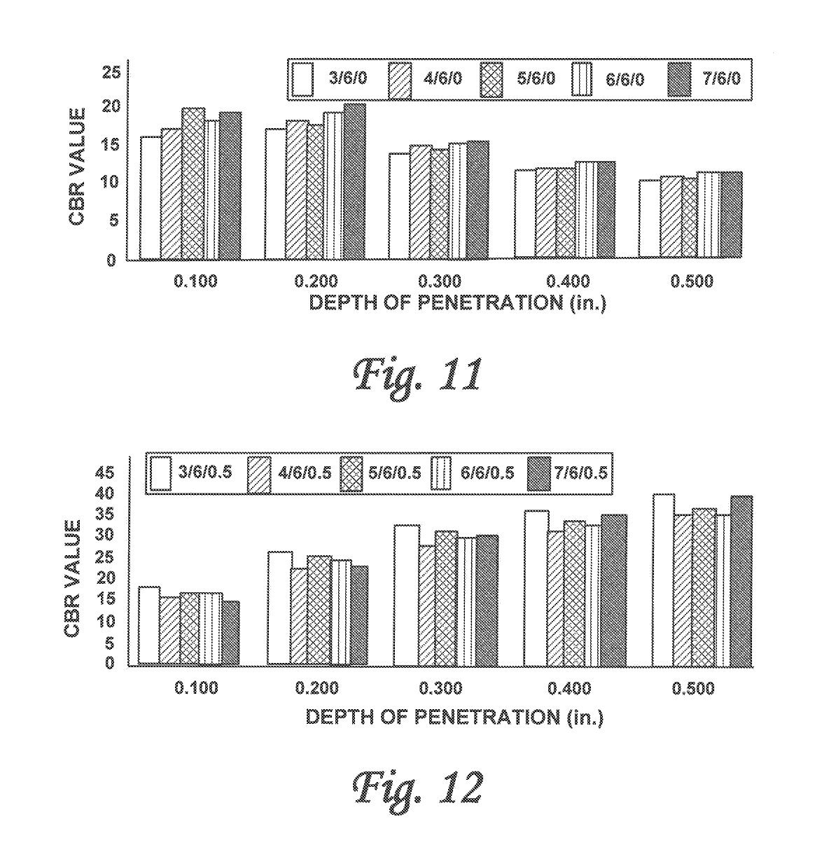

Refer to FIG. 11 plotting CBR values versus Depth of Penetration for samples of the silty sand soil used in testing select embodiments of the present invention. The soil is mixed with synthetic fluid at various wt % dry soil, water at 6 wt % dry soil and no fibers showing that optimum CBR is 6 to 7 wt % dry soil of synthetic fluid with no fibers added. Note the low values of CBR compared to FIGS. 7, 9 and 10 that mix fibers with the soil.

Refer to FIG. 12 plotting CBR values versus Depth of Penetration for samples of the silty sand soil used in testing select embodiments of the present invention mixed with fiber at 0.5 wt % dry soil, water at 6 wt % dry soil and synthetic fluid at varying wt % dry soil. It shows that CBR values increase with depth of penetration and are nearly equal for each different wt % dry soil of synthetic fluid.

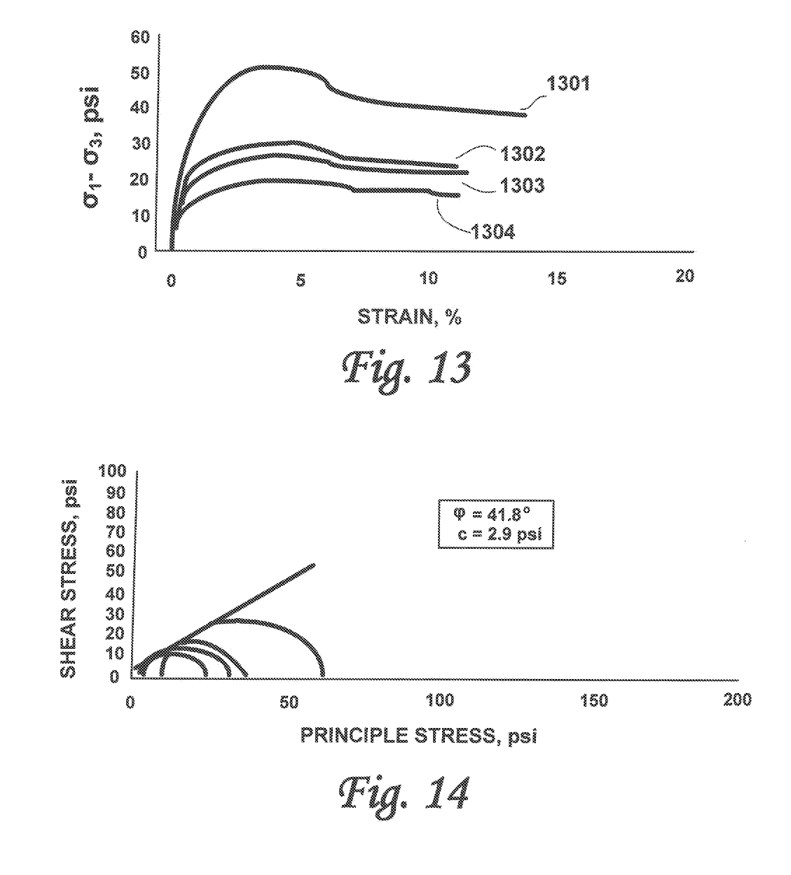

Refer to FIG. 13 plotting the deviatoric stress-axial versus strain response from a UU Triaxial test for four separate samples with water added at 11 wt % of dry soil with no synthetic fluid or fiber added and confining pressure (σ₃) values of 2.5 psi 1304, 4.0 psi 1303, 5.0 psi 1302 and 10.0 psi 1301, respectively. It shows stress peaking at about a strain of 4% for all values of σ₃, the maximum stress peaking at over 50 psi for σ₃ of 10.0 psi 1301.

Refer to FIG. 14 plotting the Mohr failure envelope for the four σ₃ values of FIG. 13 at a φ of 41.8° and c=2.9 psi. It shows peak shear stresses at different principle stresses, all less than about 40 psi for all values of σ₃.

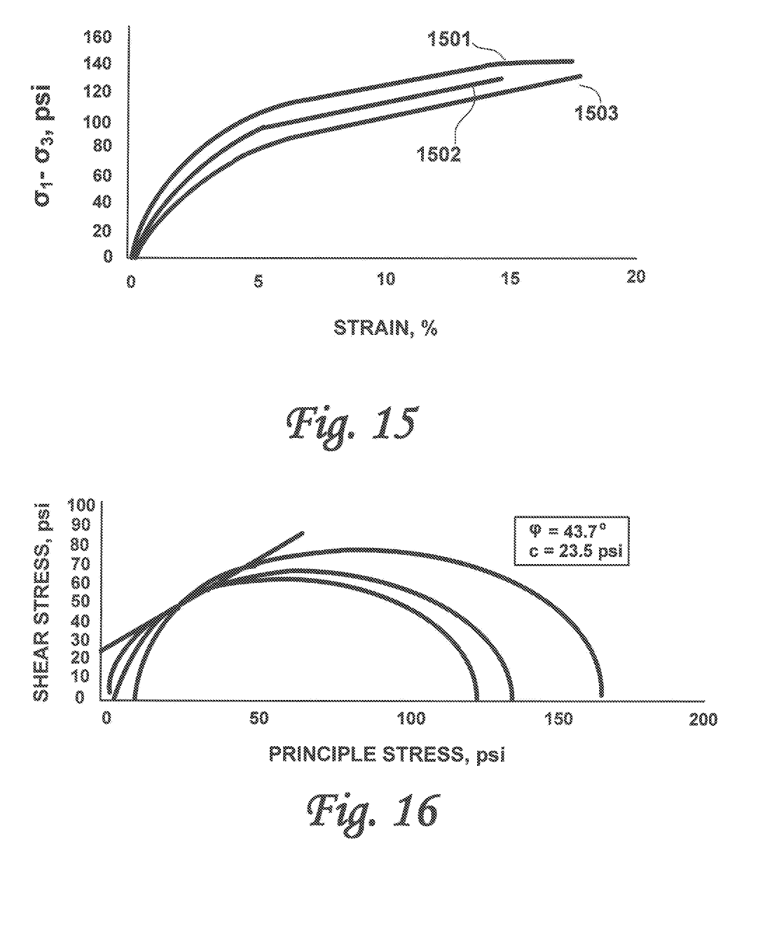

Refer to FIG. 15 plotting the deviatoric stress-axial versus strain response from a UU Triaxial test for three separate samples with water added at 11 wt % of dry soil with fibers added at 0.5 wt % dry soil and no synthetic fluid added and σ₃ values of 2.5 psi 1503, 5.0 psi 1502 and 10.0 psi 1501, respectively. It shows stress still climbing at a strain over 14% for all values of σ₃, the stress leveling at over about 150 psi for σ₃ of 10.0 psi 1501.

Refer to FIG. 16 plotting the Mohr failure envelope for the three σ₃ values of FIG. 15 at a φ of 43.7° and c=23.5 psi. It shows peak shear stresses at a principle stress of about 75 psi for all values of σ₃.

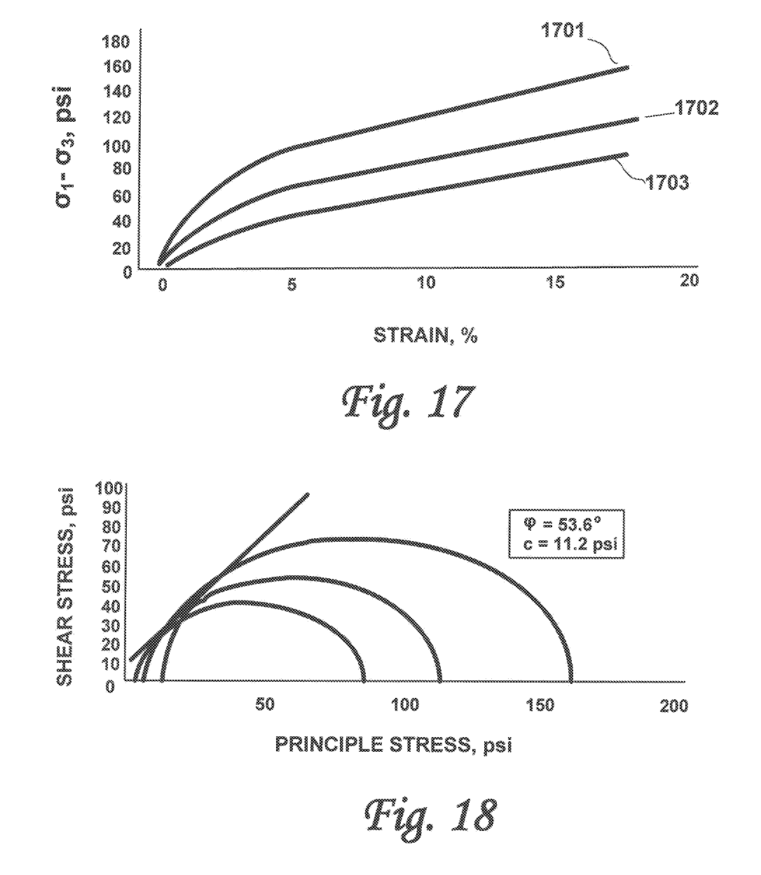

Refer to FIG. 17 plotting the deviatoric stress-axial versus strain response from a UU Triaxial test for three separate samples with water at 6 wt % of dry soil with fibers added at 0.5 wt % dry soil, synthetic fluid added at 5 wt % dry soil and σ₃ values of 2.6 psi 1703, 5.0 psi 1702 and 10.0 psi 1701, respectively. It shows stress still climbing at a strain over 17% for all values of σ₃.

Refer to FIG. 18 plotting the Mohr failure envelope for the three σ₃ values of FIG. 17 at a φ of 53.6° and c=11.2 psi. It shows peak shear stresses at unique principle stress for each value of σ₃, all but the shear stress for σ₃ of 10 psi 1701 being appreciably less than that of FIG. 16 but much greater than that of FIG. 14.

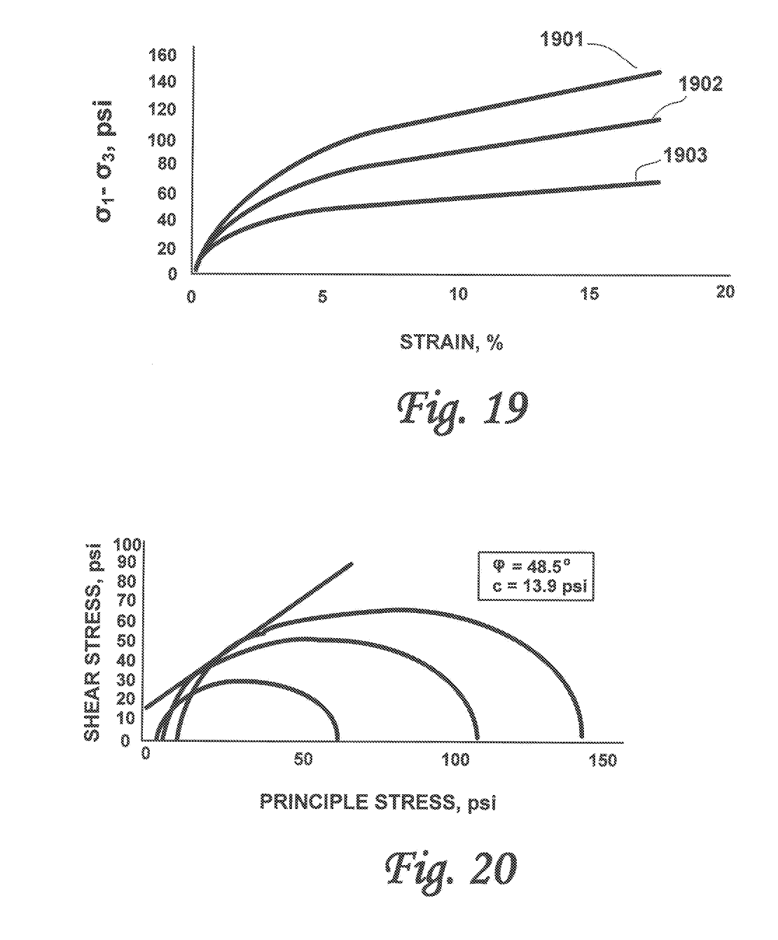

Refer to FIG. 19 plotting the deviatoric stress-axial versus strain response from a UU Triaxial test for three separate samples at a water content of 6 wt % of dry soil with fibers added at 0.5 wt % dry soil, synthetic fluid added at 3 wt % dry soil and σ₃ values of 2.5 psi 1903, 5.0 psi 1902 and 10.0 psi 1901, respectively. It shows stress still climbing at a strain over 17% for all values of σ₃.

Refer to FIG. 20 plotting the Mohr failure envelope for the three σ₃ values of FIG. 19 at a φ of 48.5° and c=13.9 psi. It shows peak shear stresses at unique principle stress for each value of σ₃, all being less than that of FIG. 18 and appreciably less than that of FIG. 16 but much greater than that of FIG. 14.

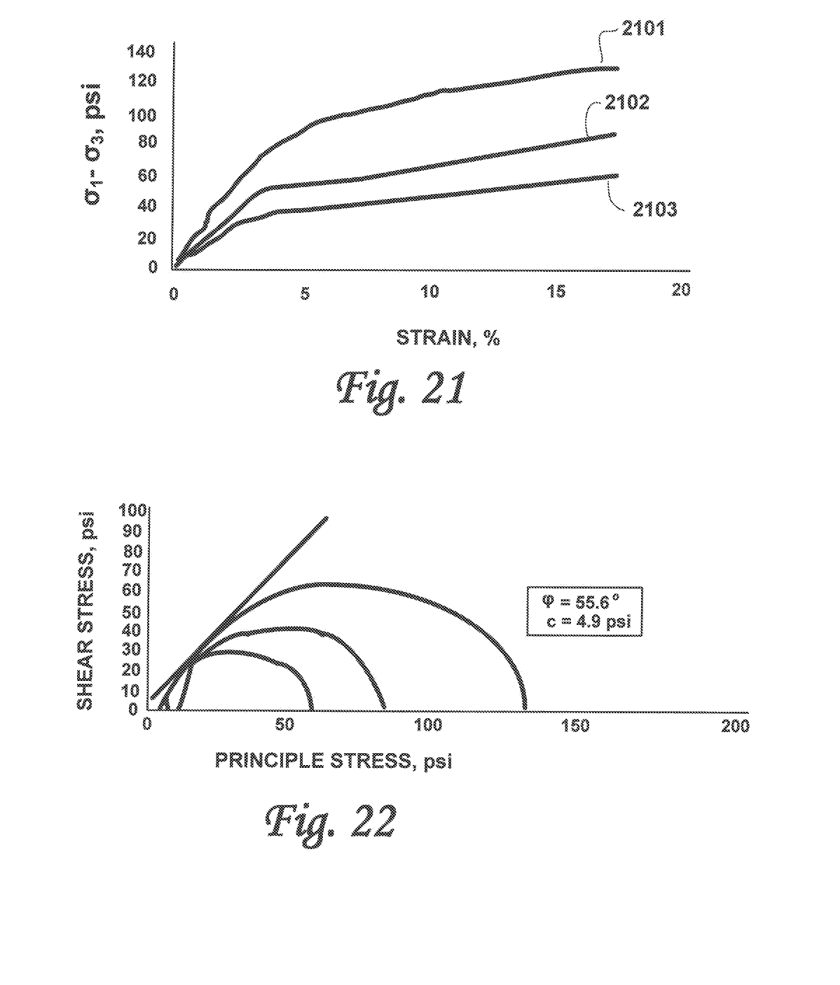

Refer to FIG. 21 plotting the deviatoric stress-axial versus strain response from a UU Triaxial test for three separate samples at a water content of 6 wt % of dry soil with fibers added at 0.5 wt % dry soil, synthetic fluid added at 7 wt % dry soil and σ₃ values of 2.5 psi 2103, 5.0 psi 2102 and 10.0 psi 2101, respectively. It shows stress still climbing at a strain over 17% for all values of σ₃.

Refer to FIG. 22 plotting the Mohr failure envelope for the three σ₃ values of FIG. 21 at a φ of 55.6° and c=4.9 psi. It shows peak shear stresses at unique principle stress for each value of σ₃, all being less than that of FIGS. 20 and 18 and appreciably less than that of FIG. 16 but much greater than that of FIG. 14.

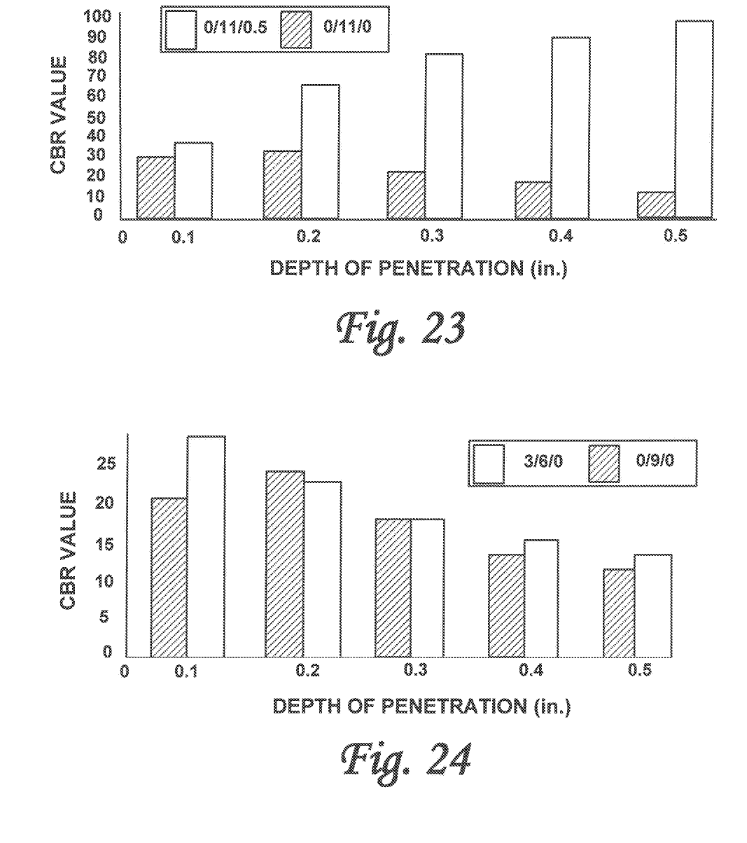

Refer to FIG. 23 plotting CBR values versus Depth of Penetration for samples of the silty sand soil used in testing select embodiments of the present invention mixed with and without fiber at 0.5 wt % dry soil, water at 11 wt % dry soil and no synthetic fluid. It shows that CBR increases steadily with depth of penetration in the soil sample with fibers added and decreases with depth of penetration in the soil sample without fibers added.

Refer to FIG. 24 plotting CBR values versus Depth of Penetration for samples of the silty sand soil used in testing select embodiments of the present invention mixed with and without synthetic fluid at 3.0 wt % dry soil, water at 6 wt % dry soil and no fibers. It shows that CBR decreases steadily with depth of penetration in the soil sample with both synthetic fluid added and no synthetic fluid added except for a penetration of 0.2 in. and until a depth of penetration of 0.4 in. the addition of synthetic fluid (alone without fibers) performs worse than water alone. Also, note the greatly reduced CBR values as compared to FIG. 23 (fibers added, no synthetic fluid).

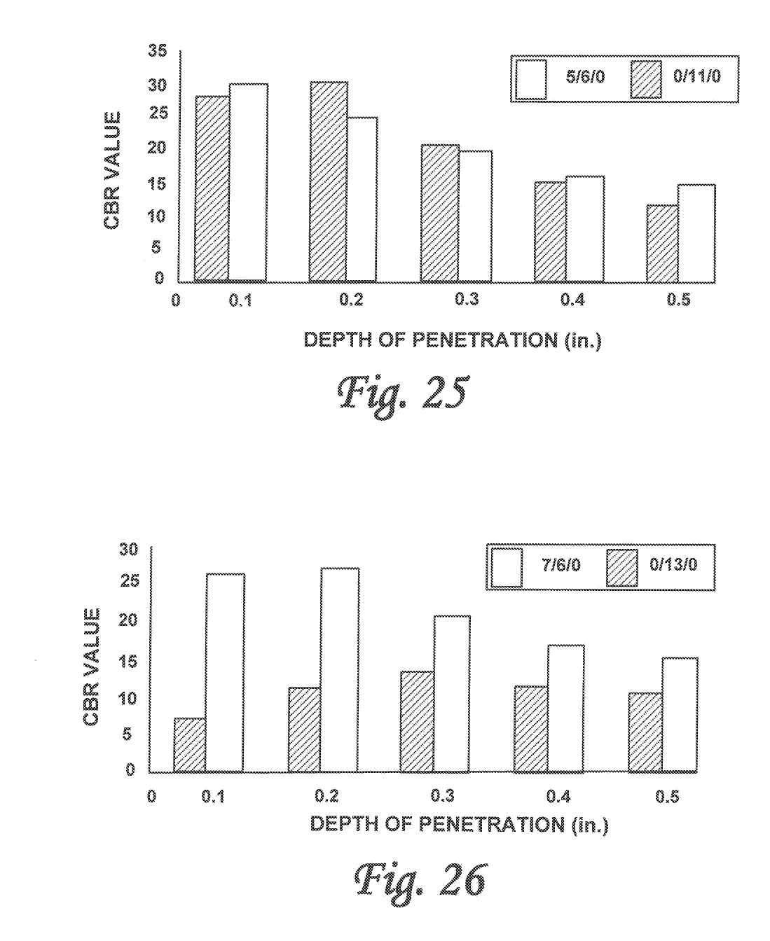

Refer to FIG. 25 plotting CBR values versus Depth of Penetration for samples of the silty sand soil used in testing select embodiments of the present invention, one sample mixed with and without synthetic fluid at 5.0 wt % dry soil, water at 6 wt % dry soil and no fibers and a second sample with water at 11.0 wt % dry soil and no synthetic fluid or fibers. It shows that CBR decreases steadily with depth of penetration in the soil sample with both synthetic fluid alone added to make a “total” moisture content of 11.0 wt % dry soil and no synthetic fluid added, except for what occurred at a penetration of 0.2 in. Until a depth of penetration of 0.4 in., the addition of synthetic fluid (alone without fibers) performs worse than water alone. Also, note the greatly reduced CBR values as compared to FIG. 23 (fibers added, no synthetic fluid).

Refer to FIG. 26 plotting CBR values versus Depth of Penetration for samples of the silty sand soil used in testing select embodiments of the present invention, one sample mixed with and without synthetic fluid at 7.0 wt % dry soil, water at 6 wt % dry soil and no fibers and a second sample with water at 13.0 wt % dry soil and no synthetic fluid or fibers. It shows that CBR decreases steadily with depth of penetration in the soil sample with both synthetic fluid alone added to make a “total” moisture content of 13.0 wt % dry soil and with the sample having no synthetic fluid added, except for what occurred at a penetration of 0.2 in. Until a depth of penetration of 0.3 in., the sample having only water increased in CBR value then decreased. The addition of synthetic fluid (alone without fibers) performs better than water alone when total moisture content is at 13 wt % dry soil. Also, note the reduced CBR values as compared to FIG. 25 (total moisture content of 11 wt % dry soil for both samples).

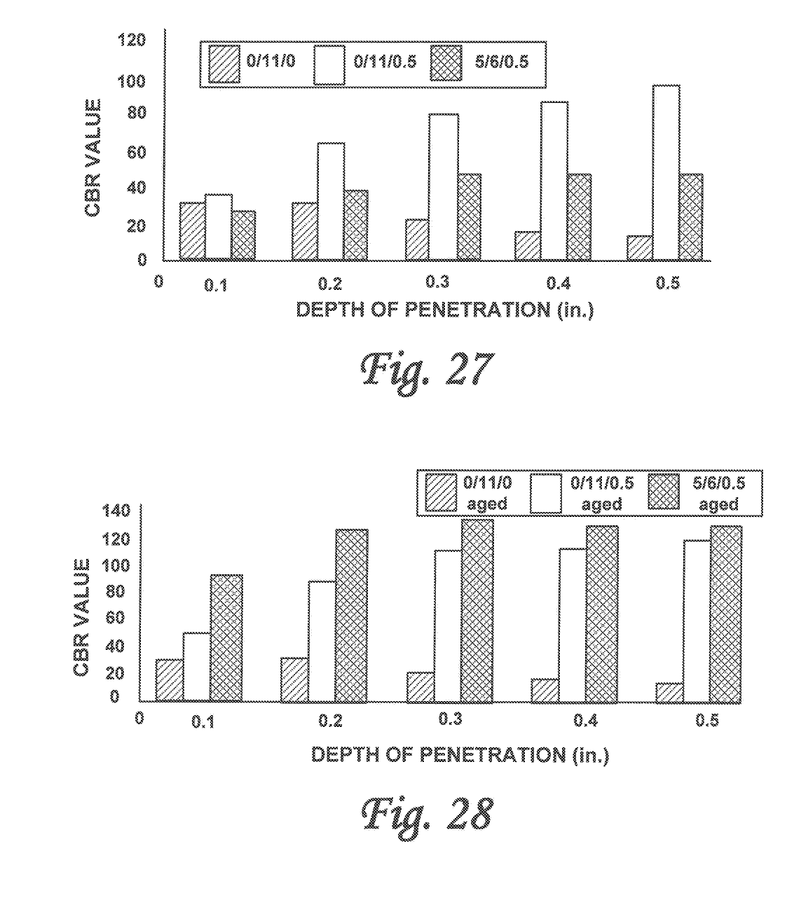

Refer to FIG. 27 plotting CBR values versus Depth of Penetration for samples of the silty sand soil used in testing select embodiments of the present invention, one sample mixed with and two without synthetic fluid; a first sample with synthetic fluid at 5.0 wt % dry soil, water at 6 wt % dry soil and fibers at 0.5 wt % dry soil; a second sample with water at 11.0 wt % dry soil and no synthetic fluid or fibers; and a third sample without synthetic fluid, water at 11.0 wt % dry soil and fibers at 0.5 wt % dry soil. It shows that CBR increases steadily with depth of penetration in the soil sample with fibers alone and with the sample having no synthetic fluid or fibers added, except decreasing steadily after a penetration of 0.2 in. The CBR of the sample with both synthetic fluid and fibers increased until a depth of penetration of 0.3 in. and then leveled, always having a lower value than the sample with only synthetic fibers. Also, note the increased CBR values (total moisture content of 11 wt % dry soil for all samples) as compared to FIGS. 24-26.

Refer to FIG. 28 plotting CBR values versus Depth of Penetration for samples of the silty sand soil used in testing select embodiments of the present invention, using the samples of FIG. 27 but aging them for 10 days. It shows that CBR increases with depth of penetration in both the soil sample with fibers alone and that with both fibers and synthetic fluid, leveling off after a penetration of 0.3 in. The CBR of the sample with neither synthetic fluid nor fibers decreased steadily with depth of penetration below 0.2 in. The sample with both fibers and synthetic fluid always had a higher CBR value than the sample with only synthetic fibers. Also, note the increased CBR values (total moisture content of 11 wt % dry soil for all samples) as compared to FIGS. 24-27.

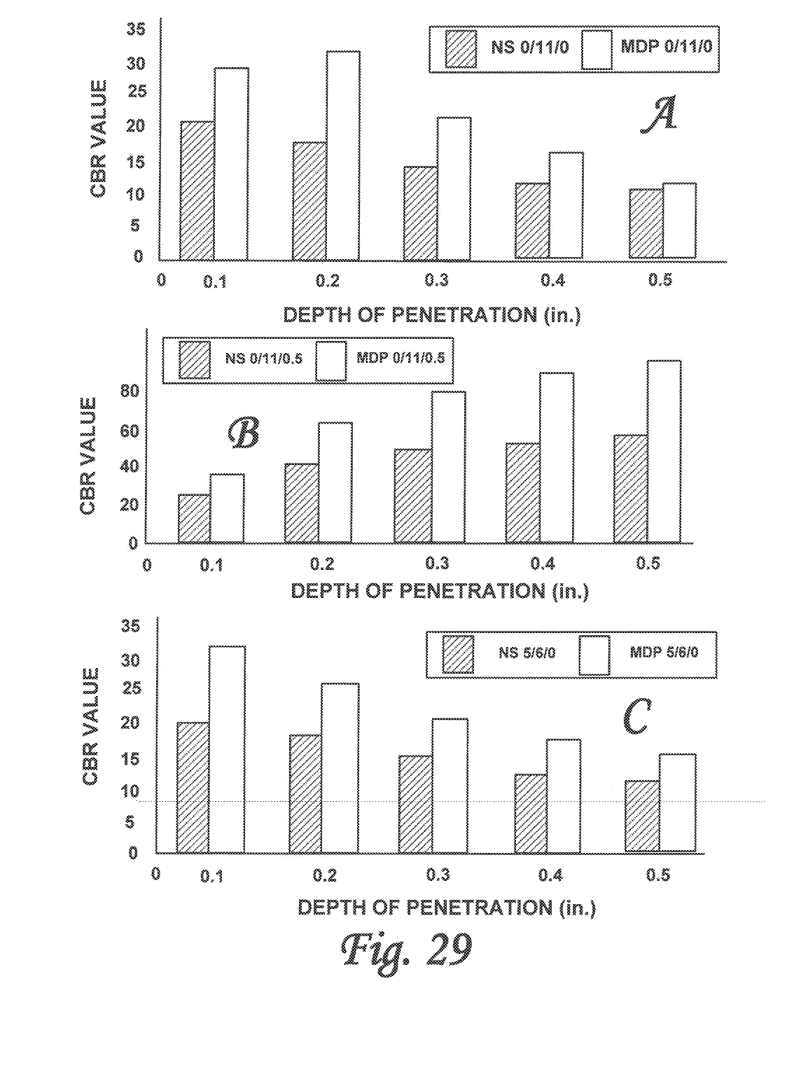

Refer to FIG. 29A plotting CBR values versus Depth of Penetration for samples of the silty sand soil used in testing select embodiments of the present invention compacted at a non-standard value (NS) and the Modified Proctor (MDP) standard with water only at 11.0 wt % dry soil. The sample compacted using the MDP standard always outperforms the NS compaction method, peaking at a penetration of 0.2 in. and decreasing steadily thereafter.

Refer to FIG. 29B plotting CBR values versus Depth of Penetration for samples of the silty sand soil used in testing select embodiments of the present invention compacted at a non-standard value (NS) and the Modified Proctor (MDP) standard with water at 11.0 wt % dry soil and added fibers at 0.5 wt % dry soil. The sample compacted using the MDP standard always outperforms the NS compaction method, increasing steadily through a penetration of 0.5 in. The sample compacted using the NS compaction standard also increased steadily through a penetration of 0.5 in. Also, note the increased CBR values (total moisture content of 11 wt % dry soil for all samples) as compared to FIG. 29A.

Refer to FIG. 29C plotting CBR values versus Depth of Penetration for samples of the silty sand soil used in testing select embodiments of the present invention compacted at a non-standard value (NS) and the Modified Proctor (MDP) standard with no fibers, water at 6.0 wt % dry soil and synthetic fluid at 5.0 wt % dry soil for a total moisture content of 11.0 wt % dry soil. The sample compacted using the MDP standard always outperforms the NS compaction method, decreasing steadily through a penetration of 0.5 in. The sample compacted using the NS compaction standard also decreased steadily through a penetration of 0.5 in. Also, note the decreased CBR values (total moisture content of 11 wt % dry soil for all samples) as compared to FIG. 29B and rough equivalence to FIG. 29A.

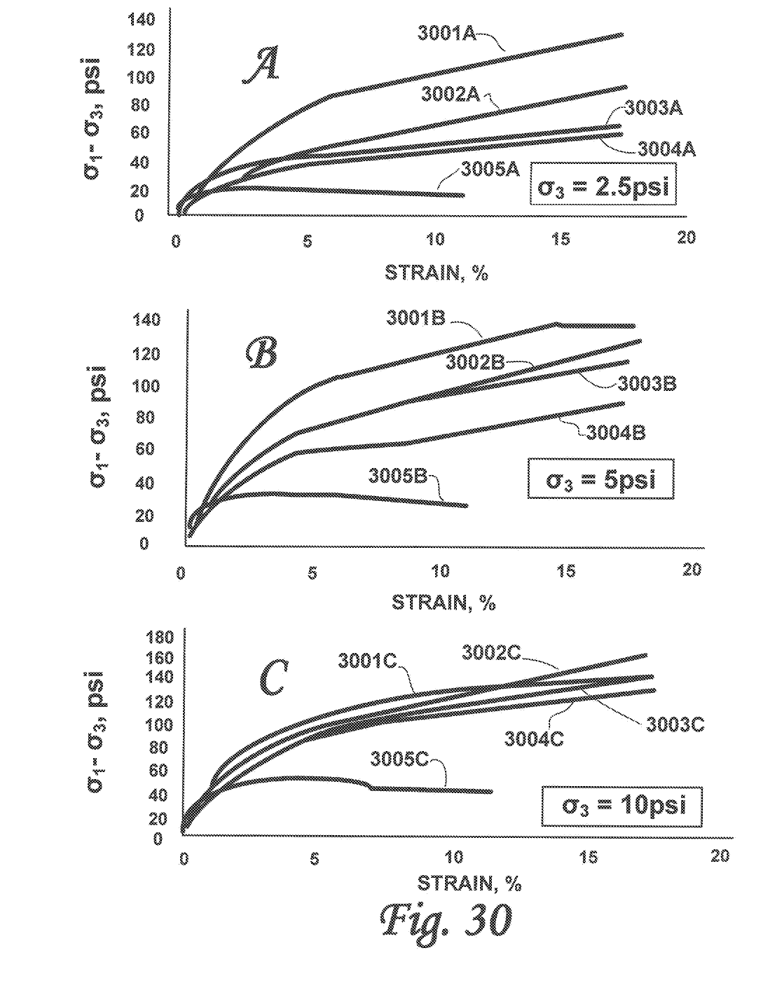

Refer to FIG. 30A plotting the deviatoric stress-axial versus strain response from a UU Triaxial test for five separate samples: a) water only at 11.0 wt % dry soil 3005A; b) water at 0.5 wt % dry soil and fibers at 0.5 wt % dry soil 3004A; c) synthetic fluid at 5.0 wt % dry soil, water at 6.0 wt % dry soil and fibers at 0.5 wt % dry soil 3003A; d) synthetic fluid at 7.0 wt % dry soil, water at 6.0 wt % dry soil and fibers at 0.5 wt % dry soil 3002A and e) synthetic fluid at 3.0 wt % dry soil, water at 11.0 wt % dry soil and fibers at 0.5 wt % dry soil 3001A, all samples at a confining pressure of 2.5 psi. Only the first sample 3005A, with neither fibers nor synthetic fluid, “flattens” out immediately. The second 3004A and third 3003A samples behave similarly, indicating little effect of adding synthetic fluid to the mixture when water content is held at 6.0 wt % dry soil.

Refer to FIG. 30B plotting the deviatoric stress-axial versus strain response from a UU Triaxial test for the five separate samples of FIG. 30A but at an increased confining pressure of 5.0 psi. Again, only the first sample 3005B, with neither fibers nor synthetic fluid, “flattens” out immediately. The third 3003B and fourth 3002B samples behave similarly, indicating little effect of adding synthetic fluid to the mixture when water content is held at 6.0 wt % dry soil. Most likely due to the increased confining pressure, the second sample 3004B has a much higher stress than for the same sample 3004A at a confining pressure of 2.5 psi. The first sample 3001B ends at the same place as the first sample 3001A under a confining pressure of 2.5 psi but has a steeper curve at a strain below about 5%.

Refer to FIG. 30C plotting the deviatoric stress-axial versus strain response from a UU Triaxial test for the five separate samples of FIG. 30A but at an increased confining pressure of 10.0 psi. Again, only the first sample 3005C, with neither fibers nor synthetic fluid, “flattens” out immediately. At the significantly increased confining pressure all the samples 3001C through 3004C behave similarly, indicating the beneficial effect of compacting any mixture, regardless of content. A confining pressure of 10 psi may be impractical in field use, however.

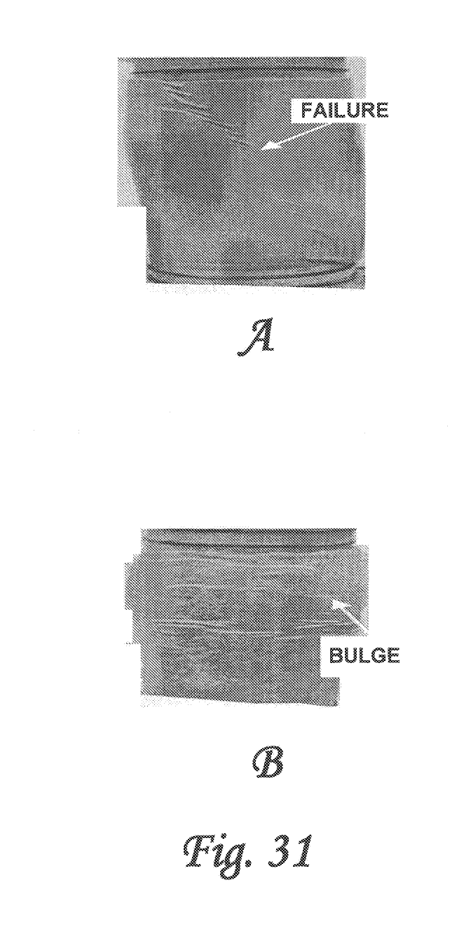

Refer to FIG. 31 demonstrating the failure mode of a untreated soil A as compared to a soil B treated with a select embodiment of the present invention.

Additional CBR tests were conducted with non-standard compaction and may be used to quantify soil improvement by compaction. See discussion of FIG. 29 above. For non-standard compaction, compaction was performed in accordance with ASTM D698-00a, except that a drop height of eighteen inches was used instead of twelve inches. The six-inch molds used conformed to the requirements of ASTM D698-00a. Compaction was performed by a SoilTest Mechanical Soil Compactor (model CN-4235). A sectional foot was used on the mechanical rammer for compaction of all samples.

Unconsolidated, Undrained (UU) triaxial compressive strength tests were performed on native soil samples compacted at OMC, geofiber-reinforced samples at OMC, and samples improved with a combination of geofiber and synthetic fluid. The AASHTO T 296-05 procedure was followed for all of the UU tests. The soil samples subjected to UU tests were classified in five groups. Following the nomenclature established for CBR testing above, the results from each group are labeled as “SFC/MC/F”, where SFC is the synthetic fluid content as wt % dry soil, MC is the moisture content as wt % dry soil, and F is the geofiber content as wt % dry soil. The soil sample groups are samples prepared at mixtures of 0/11/0, 0/11/0.5, 5/6/0.5, 3/6/0.5 and 7/6/0.5. Three soil samples were prepared for each group and each of these samples was tested at a different confining pressure. The confining pressures were 2.5 psi, 5 psi and 10 psi. Refer to the discussion of FIGS. 15 through 22 above.

Unless otherwise stated, compaction was done in accordance with ASTM D1557-02. CBR tests on unimproved native soil at the OMC were used as a baseline for comparison.

### Comparative Results

Again refer to FIG. 23, a comparison of the native soil mixed with water at the OMC and fiber-reinforced soil mixed with water and geofibers at the OMC and optimum fiber content (OFC), respectively. The fiber-reinforced soil demonstrates a substantial improvement in CBR values over unimproved soil and increases with deeper penetration, e.g., improvement at 0.1 in. is 25%; at 0.2 in. is 102.5%, and improvement continues up to 727.2% at 0.5 in.

Again refer to FIGS. 24, 25 and 26 comparing CBR values between samples with similar total liquid contents. In all three comparisons, test samples containing the synthetic fluid and water mixture yield better results at the surface, i.e., 0.1 in., than samples mixed with water only. In FIG. 24 the synthetic fluid sample showed a 36.7% improvement over the water-only sample. In FIG. 25, the improvement was 6.6%.

Again referring to FIG. 16, test samples with total liquid contents above the OMC showed significant improvement in samples containing the synthetic fluid and water mixtures, and a marked reduction in strength in the water-only samples. The synthetic fluid sample demonstrated a 280.6% improvement over the sample with water at the 0.1 in. depth of penetration. Improvement diminishes from 146.4% at the 0.2 in. to 44.8% at 0.5 in.

During compaction of samples with 7 wt % synthetic fluid and 6 wt % water, no bleedout liquid was noted. This is a notable difference between the two samples with total liquid content of 13 wt %. There was substantial bleedout on the samples that contained 13 wt % water. Thus, the synthetic fluid reduces or restricts matrix water migration in soil during compaction as well as during penetration testing for CBR.

Soils stabilized by both geofibers and synthetic fluid with a total liquid content of 11% demonstrated improvement over native soil at the OMC. Soil with synthetic fluid and geofiber yielded CBR values lower than those for fiber-reinforced soil samples without the synthetic fluid. Again refer to FIG. 27 comparing CBR values between samples with a total liquid content of 11.0 wt % dry soil, with and without fiber. As noted from FIG. 4, improvement of the native soil by adding geofibers, at 0.2 in. depth of penetration, was 102.5%. By comparison, in FIG. 27, the improvement by adding geofibers and synthetic fluid, at the same depth of penetration, is 20.6%.

Again refer to FIG. 28, depicting the effect of aging after compacting. Aged samples illustrate the benefits of synthetic fluid for soil stabilization to offset an apparent early bearing capacity reduction. As shown in FIG. 28, the CBR values for the aged (approximately 10 days) sample 5/6/0.5 is higher than both the aged samples 0/11/0.5 and 0/11/0.5. The improvement with aging for the optimum combination of 5/6/0.5 is about 340% at 0.2 in. depth of penetration. Much larger improvements were recorded at larger penetration depths, e.g., at 0.5 in., the improvement of the 5/6/0.5 sample is about 1007.4% over the non-aged, non-stabilized native soil sample 0/11/0.

Note that in FIG. 28, the CBR value for the 0.5 in. penetration depth of the 5/6/0.500 sample is an estimated value. The test load would have slightly exceeded the capacity of the test apparatus, i.e., greater than 10,000 lbf, and the test was stopped to prevent damage to the apparatus. A conservative value of 10,000 lbf was used to calculate the bearing ratio at this data point.

It is common in field applications to encounter lower compaction than specified. To address the effect of compaction on soil improvement, a series of CBR tests were performed on samples prepared with “non-standard” compaction. For the non-standard compaction, compaction was performed in accordance with ASTM D698-00a except that a drop height of eighteen inches was used instead of twelve inches. The six-inch molds used conformed to the requirements of ASTM D698-00a. Thus, the compaction should correspond to somewhere between Standard Proctor and Modified Proctor. Again refer to FIG. 29A, presenting a comparison between the Modified Proctor and non-standard lower compaction in terms of CBR tests performed on native soil samples at a moisture content of 11.0 wt % dry soil. The impact of compaction is significantly pronounced at 0.2 in. penetration depth, indicating a CBR value of about 32 from the Modified Proctor versus 17 from the non-standard compaction. The samples prepared with Modified Proctor have consistently resulted in higher CBR values for cases where the soil was improved with geofiber, as seen in FIG. 29B, and also with the addition of synthetic fluid, as displayed in FIG. 29C. These comparisons confirmed that compaction plays an important role in improving soil strength.

UU triaxial compressive strength tests were performed on native soil samples compacted at OMC, geofiber-reinforced samples at OMC, and samples improved with a combination of geofiber and synthetic fluid. Three soil samples were prepared for each group, and each of these samples was tested at a different confining pressure. Again refer to FIG. 30, comparing the deviatoric stress-axial strain responses at each confining pressure of 2.5 psi, 5.0 psi and 10.0 psi. The unimproved native soil samples exhibit typical strain softening behavior past about 5% axial strain with consistently lower strength than that of the improved samples. Soil improvement with either geofiber reinforcement or a combination of geofiber and synthetic fluid resulted in significant behavior changes. The improved soil was found to show strain hardening behavior, as opposed to the strain softening tendency apparent when left unimproved. Further, at all confining pressures, the best performance was obtained from geofiber-reinforced samples. The samples improved with a combination of geofiber reinforcement and synthetic fluid having more strength than the unimproved samples, yet less strength than those improved with geofiber only when not aged after compaction. The difference in strength between improved samples was found to be less pronounced at a relatively high confining pressure of 10 psi as shown in FIG. 30C.

Note that the failure mechanisms of the improved and unimproved samples were different. FIG. 31 displays two post-testing photos A, B of failed samples for unimproved and geofiber-reinforced conditions. The failure of the unimproved soil sample A shows a clear 45°+(σ/2) failure plane whereas the geofiber-reinforced sample B appears to fail by bulging without a distinct failure plane. At large strains geofibers fully engage and prevent the occurrence of such failure plane.

### Soil Type

Bethel silty sand was found to have an optimum moisture (water) content of 11.0 wt % dry soil. The CBR value at optimum moisture content without stabilizers was found to be 31 (at 0.2 in. penetration). This CBR value falls within the typical range (20-40) for SM type silty sand. The optimum geofiber content, which corresponds to the largest CBR value, appears to be about 0.5%. Lower or higher geofiber contents resulted in lower CBR values. Addition of 0.5 wt % dry soil geofiber at optimum moisture content of 11.0 wt % dry soil increased the CBR value from 31 to 62 at 0.2 in. penetration and to much higher values at larger penetrations. Thus, the improvement in the CBR values by adding 0.5 wt % dry soil geofiber to the soil was 100% and above. In terms of CBR values, the geofiber-reinforced (improved) soil appears to be in the range of well-graded gravel or sandy gravel, for which the CBR ranges from 60 to 80. In an effort to determine the optimum synthetic fluid content, it was found that the synthetic fluid would only work when used with some original moisture (water) in the soil. The optimum combination of synthetic fluid content/water content was found to be 5%/6%. Also, note that the total liquid content in the soil in this case is 11.0 wt % dry soil, which is equal to the optimum moisture content determined for the native (no stabilizer added) soil. Addition of the synthetic fluid alone did not provide a noticeable improvement in the CBR values. In general, the CBR values obtained from the soil samples improved with synthetic fluid were very similar to those obtained from unimproved soil samples at optimum moisture content. Compaction is significant in the effectiveness of the stabilizers, especially for the geofibers. Increasing compaction from a non-standard low to Modified Proctor resulted in 50% higher CBR values.

Refer to Table 1. The study of soil-strength characteristics through UU triaxial compression tests indicated a friction angle of 41.8° and a slight cohesion of 2.9 psi from native (no stabilizer added) soil samples compacted (Modified Proctor) at the optimum moisture content of 11.0 wt % dry soil. When 0.5 wt % dry soil geofiber was added to the soil, the cohesion increased significantly from 2.9 psi to 23.5 psi, while the friction angle increased by about 2°. However, the addition of synthetic fluid along with geofibers showed a less pronounced increase in cohesion with a more significant improvement in the friction angle. The cohesion and friction angle for the latter case were 11.2 psi and 53.6°, respectively. The UU triaxial compression tests showed the failure mode changes from a distinct 45°+(σ/2) failure plane for unimproved soil samples to a bulging-type failure with no distinct failure plane in the case of geofiber-reinforced soil samples (dilative to contractive). Based on the results of both CBR and UU triaxial compression tests, to get the best performance from the Bethel silty sand, the optimum combination of synthetic fluid content/moisture content/geofiber content was found to be 5/6/0.5. Aging soil samples by approximately ten days yielded a further significant improvement in the CBR values. The improvement in the CBR value with aging, for the optimum combination of 5/6/0.5 was found to be on the order of 340%, i.e., CBR increased from 36 for a non-aged sample to 124 for an aged sample.

TABLE 1
Summary of UU Triaxial Test Results

| | Water (wt | | | |
|---|---|---|---|---|
| Synthetic Fluid | % | Geofiber | Friction Angle | |
| (wt % dry soil) | dry soil) | (wt % dry soil) | (degrees) | Cohesion |
| — | 11 | — | 41.8 | 2.9 |
| — | 11 | 0.5 | 43.7 | 23.5 |
| 5 | 6 | 0.5 | 53.6 | 11.2 |
| 3 | 6 | 0.5 | 48.5 | 13.9 |
| 7 | 6 | 0.5 | 55.6 | 4.9 |

The abstract of the disclosure is provided to comply with the rules requiring an abstract that will allow a searcher to quickly ascertain the subject matter of the technical disclosure of any patent issued from this disclosure. (37 CFR §1.72(b)). Any advantages and benefits described may not apply to all embodiments of the invention.

While the invention has been described in terms of some of its embodiments, those skilled in the art will recognize that the invention can be practiced with modifications within the spirit and scope of the appended claims. For example, although the system is described in specific examples for stabilizing soil, in particular silty sands, it may be used for any type of stabilization procedure and thus may be useful in such diverse applications as landscaping, landslide prevention, farming, mining, drilling, remediating, environmental intervention, military operations and the like. Soils may be of any type ranging from fine sand to dense clays. In the claims, means-plus-function clauses are intended to cover the structures described herein as performing the recited function and not only structural equivalents, but also equivalent structures. Thus, although a nail and a screw may not be structural equivalents in that a nail employs a cylindrical surface to secure wooden parts together, whereas a screw employs a helical surface, in the environment of fastening wooden parts, a nail and a screw may be equivalent structures. Thus, it is intended that all matter contained in the foregoing description or shown in the accompanying drawings shall be interpreted as illustrative rather than limiting, and the invention should be defined only in accordance with the following claims and their equivalents.

We claim:

1. A soil stabilization system comprising:
a fluid mixture comprising at least one lipophilic fluid; and
fibers,
wherein said fluid mixture and said fibers are mixed into soil having a pre-specified moisture content to create an approximately homogeneous mixture of said soil, said fibers and said fluid mixture, and
wherein said homogeneous mixture is compacted to a pre-specified standard and aged for a pre-specified time.

2. The soil stabilization system of claim 1, said lipophilic fluid comprising a highly branched isoalkane having about 10 to about 25 carbon atoms and said fluid mixture further comprising at least biodiesel fuel.

3. The soil stabilization system of claim 2, said isoalkane remaining liquid to at least about −60° F.

4. The soil stabilization system of claim 1, said fluid mixture further comprising at least one petroleum-based fluid.

5. The soil stabilization system of claim 1, said fibers comprising synthetic fibers.

6. The soil stabilization system of claim 1, said fibers selected from the group consisting of: nylon, polyvinyl alcohol, polyethylene, polypropylene, natural rubber, synthetic rubber, styrene butadiene, isoprene, cellulose and combinations thereof.

7. The soil stabilization system of claim 1, said fibers comprising monofilament fibers.

8. The soil stabilization system of claim 1, said fibers comprising fibrillated fibers.

9. The soil stabilization system of claim 1, said fibers having a length of about 6.25 mm (about 0.25 inches) to about 100 mm (about 4 inches).

10. A stabilized soil comprising:
a soil having a pre-specified moisture content;
a fluid mixture comprising at least one lipophilic fluid; and
fibers;
wherein said fluid mixture and said fibers are mixed in said soil to create an approximately homogeneous mixture of said soil, said fibers and said fluid mixture, and
wherein said homogeneous mixture is compacted to a pre-specified standard and aged for a pre-specified time.

11. The stabilized soil of claim 10 in which said lipophilic fluid comprises a highly branched isoalkane having about 10 to about 25 carbon atoms and said fluid mixture further comprises at least biodiesel.

12. The stabilized soil of claim 11 in which said isoalkane remains liquid down to at least about −60° F.

13. The stabilized soil of claim 10 in which said fibers are selected from the group consisting of: nylon, polyvinyl alcohol, polyethylene, polypropylene, natural rubber, synthetic rubber, styrene butadiene, isoprene, cellulose and combinations thereof.

14. The stabilized soil of claim 10 in which said pre-specified moisture content is maintained approximately at a pre-specified weight percent of dry soil.

15. The stabilized soil of claim 14 comprising said fluid mixture at about 5 wt % dry soil, said moisture at about 6 wt % dry soil and said fibers at about 0.5 wt % dry soil.

16. A method of stabilizing soil, comprising:
providing said soil at a pre-specified approximate moisture content;
providing a fluid mixture comprising at least one lipophilic fluid;
providing fibers; and
mixing into said soil said fluid mixture and said fibers to achieve an approximately homogeneous mixture of said soil at a pre-specified approximate moisture content, said fluid mixture and said fibers,
compacting said approximately homogeneous mixture to a pre-specified standard; and
aging said compacted homogeneous mixture for a pre-specified period.

17. The method of stabilizing soil of claim 16, providing said lipophilic fluid as a highly branched isoalkane having 10 to about 25 carbon atoms and providing said fluid mixture further comprising at least biodiesel fuel.

18. The method of stabilizing soil of claim 13, providing said isoalkane that remains liquid down to about −60° F.

19. The method of stabilizing soil of claim 16, providing said fibers selected from the group consisting of: nylon, polyvinyl alcohol, polyethylene, polypropylene, natural rubber, synthetic rubber, styrene butadiene, isoprene, cellulose and combinations thereof.

20. The method of stabilizing soil of claim 16, further comprising adjusting said moisture content of said soil to a pre-specified percent dry weight of soil.

21. The method of stabilizing soil of claim 16 in which said pre-specified standard comprises the Modified Proctor compaction method.

22. The method of stabilizing soil of claim 16 in which said pre-specified period is about ten days.

23. The method of stabilizing soil of claim 16, providing said fluid mixture in a range of about 1 to about 10 wt % dry soil and said fibers in a range of about 0.1 to 2 wt % dry soil to a soil with a moisture content in a range of about 2 to about 10 wt % dry soil.

24. Structure built on stabilized soil, said stabilized soil comprising:
a soil having a pre-specified moisture content;
a fluid mixture comprising at least one lipophilic fluid; and
fibers;
wherein said fluid mixture and said fibers are mixed in said soil to create an approximately homogeneous mixture of said soil having a pre-specified moisture content, said fibers and said fluid mixture, and
wherein said homogeneous mixture is compacted to a pre-specified standard and aged for a pre-specified time.

25. A method of constructing a foundation, said method at least comprising:
testing soil to be used in said foundation to determine at least moisture content thereof;
adjusting said soil to at least a pre-specified moisture content;
providing a fluid mixture comprising at least one lipophilic fluid;
providing fibers; and
mixing into said soil of an adjusted pre-specified moisture content said fluid mixture and said fibers to achieve an approximately homogeneous mixture of said soil of an adjusted pre-specified moisture content, said fluid mixture and said fibers,
compacting said homogeneous mixture to a pre-specified standard; and
aging said compacted homogeneous mixture for a pre-specified period,
wherein said method yields stabilized soil for said foundation.
